(19) United States
(12) Patent Application Publication
(10) Pub. No.: US 2021/0278942 A1
(43) Pub. Date: Sep. 9, 2021

(54) MOBILE TERMINAL, AN ELECTRONIC DEVICE HAVING A MOBILE TERMINAL, AND CONTROL METHOD OF THE ELECTRONIC DEVICE

(71) Applicant: LG ELECTRONICS INC., Seoul (KR)

(72) Inventor: Jaehee JUNG, Seoul (KR)

(73) Assignee: LG ELECTRONICS INC., Seoul (KR)

(21) Appl. No.: 16/985,189

(22) Filed: Aug. 4, 2020

(30) Foreign Application Priority Data
Mar. 9, 2020 (KR) 10-2020-0029176

(51) Int. Cl. G06F 3/0486; G06F 3/0482; H04M 1/02; G06F 3/0481

(52) U.S. Cl. CPC G06F 3/0486; G06F 3/0482; H04M 2250/22; G06F 3/04817; H04M 2250/16; H04M 1/0216

(57) ABSTRACT

Embodiments relate to an electronic device including a mobile terminal on which a plurality of applications is executed and a case thereof, wherein the mobile terminal includes a terminal body coupled to the case, a connection port provided on one side of the terminal body, a first display, and a controller, wherein the controller is configured to: display a list on the first display, detect a drag on the list, and display an execution screen of an application corresponding to the drag on the second display, wherein the list corresponds to the plurality of applications.

### CROSS-REFERENCE TO RELATED APPLICATION

Pursuant to 35 U.S.C. § 119(a), this application claims the benefit of the earlier filing date and the right of priority to Korean Patent Application No. 10-2020-0029176, filed on Mar. 9, 2020, the contents of which is incorporated by reference herein in its entirety.

### BACKGROUND

### 1. Technical Field

Embodiments relate to a mobile terminal, an electronic device having a case to which the mobile terminal is coupled, and a control method of the electronic device.

### 2. Description of the Related Art

In general, terminals may be divided into mobile/portable devices and stationary devices according to mobility. Mobile terminals may also be classified as handheld terminals or vehicle mounted terminals according to whether or not a user can directly carry the terminal.

Functions of mobile terminals have been diversified. Examples of such functions include data and voice communications, capturing images and video via a camera, recording audio, playing music files via a speaker system, and displaying images and video on a display. Some mobile terminals additionally provide functions such as playing an electronic game, or executing a function of multimedia players. Especially, recent mobile terminals may receive multicast signal for providing visual content such as broadcasts, videos, or television programs.

As it becomes multifunctional, a mobile terminal can be allowed to capture still images or moving images, play music or video files, play games, receive broadcast and the like, so as to be implemented as an integrated multimedia player.

Meanwhile, by playing different contents on a plurality of screens in which additional screens are connected to a mobile terminal by wire or in a wireless manner, a function of allowing multiple users to simultaneously play different contents by using one mobile terminal is included.

However, in the related art mobile terminal, there is a problem in that when an application execution list is dragged, an application corresponding to the drag is ended.

### SUMMARY

The embodiments are intended to overcome the above-described problems, and an aspect of the embodiments is to provide a mobile terminal capable of extending a display area of the mobile terminal, and a case to which the mobile terminal is coupled, with the case having an additional display interworking with the mobile terminal.

In addition, an embodiment is to provide an electronic device and a control method thereof capable of controlling a display provided on a case by a wired communication so that the case is compatible with various models and does not need a separate chip for communication.

Further, an embodiment is to display a running application on a desired display among a plurality of displays without terminating the application.

In addition, an embodiment is to display applications on a plurality of displays by dragging application lists.

In addition, an embodiment is to display applications on a plurality of displays by displaying application lists on the plurality of displays at the same time.

In addition, an embodiment is to control priorities of application lists by dragging application lists.

The technical problems to be solved by the embodiments are not limited to the technical problems described above, and other technical problems not described may be clearly understood by those skilled in the art having ordinary knowledge from the description of the examples.

To achieve the aspect and other advantages of the present disclosure, there is provided an electronic device including a mobile terminal on which a plurality of applications is executed, and a case thereof, wherein the mobile terminal includes a terminal body coupled to the case, a connection port provided on one side of the terminal body, a first display, and a controller, wherein the case includes a first body accommodating the terminal, a connector protruded toward an inner side of the first body and inserted into the connection port, a second display, a connection portion disposed between the first display and the second display and electrically connecting the second display with the first body and the second body, wherein the controller is configured to display a list on the first display, detect a drag on the list, and display an execution screen of an application corresponding to the drag on the second display, wherein the list corresponds to the plurality of applications.

In addition, the list of the electronic device according to an embodiment includes a plurality of thumbnails corresponding to the plurality of applications, wherein the thumbnails are representative screens of each of the plurality of executed applications, and the controller is further configured to display the plurality of thumbnails sequentially in a first direction.

In addition, the plurality of thumbnails of the electronic device according to an embodiment includes a first thumbnail, and the drag includes a first drag and a second drag corresponding to the first thumbnail, the controller is further configured to display an execution screen of a first application corresponding to the first thumbnail on the second display according to the first drag, and end the first application according to the second drag, and wherein a direction of the first drag is opposite to a direction of the second drag.

Further, a direction of the first drag of the electronic device according to an embodiment is from the first display to the second display, and a direction of the second drag is from the second display to the first display.

Further, the plurality of thumbnails of the electronic device according to an embodiment further includes a second thumbnail, the drag includes a third drag and a fourth drag corresponding to the second thumbnail, the controller is further configured to display the list on the first display and the second display simultaneously, display an execution screen of an application corresponding to the second thumbnail on the first display according to the third drag on the second display, and end the application corresponding to the second thumbnail according to the fourth drag on the second display, wherein a direction of the third drag is opposite to a direction of the fourth drag.

Further, a direction of the third drag of the electronic device according to an embodiment is from the second display to the first display, and a direction of the fourth drag is from the first display to the second display.

In addition, the drag of the electronic device according to an embodiment includes a fifth drag corresponding to the first thumbnail and a sixth drag corresponding to the second thumbnail, wherein the fifth drag and the sixth drag cross each other, and the controller is further configured to divide the first display into a first region and a second region according to the fifth drag and the sixth drag.

In addition, the controller of the electronic device according to an embodiment is further configured to display an execution screen of an application corresponding to the first thumbnail in the first region according to the fifth drag, and display an execution screen of an application corresponding to the second thumbnail in the second region according to the sixth drag, wherein the fifth drag and the sixth drag intersect each other perpendicularly.

In addition, the controller of the electronic device according to an embodiment is further configured to display the plurality of thumbnails sequentially in a second direction, and according to a seventh drag, display an application corresponding to the seventh drag to be a most significant application on the first display, wherein the seventh drag corresponds to any one of the plurality of thumbnails, and the second direction is perpendicular to the first direction.

Another embodiment provides a method for controlling an electronic device including a mobile terminal on which a plurality of applications is executed, and a case thereof, wherein the mobile terminal includes a terminal body coupled to the case, a connection port provided in the terminal, a first display, and a controller, wherein the case includes a first body accommodating the terminal, a connector protruded toward an inner side of the first body and inserted into the connection port, a second display, a connection portion electrically connecting the second display with the first body and the second body, and wherein the mobile terminal further includes a controller configured to control the first display and the second display. And the method includes displaying a list on the first display, and detecting a drag of the list and displaying an execution screen of an application corresponding to the drag on a second display, wherein the list corresponds to the plurality of applications.

In addition, the list in the method according to an embodiment includes a plurality of thumbnails corresponding to the plurality of applications, and the thumbnails are representative screens of each of the plurality of executed applications, wherein the displaying a list on the first display includes displaying the plurality of thumbnails sequentially in a first direction.

In addition, the plurality of thumbnails in the method according to an embodiment includes a first thumbnail, the drag includes a first drag and a second drag corresponding to the first thumbnail, and the method further includes displaying an execution screen of a first application corresponding to the first thumbnail on the second display according to the first drag, and ending the first application according to the second drag, wherein a direction of the first drag is opposite to a direction of the second drag.

Further, a direction of the first drag in the method according to an embodiment is from the first display to the second display, and a direction of the second drag is from the second display to the first display.

In addition, the plurality of thumbnails in the method according to an embodiment further includes a second thumbnail, the drag includes a third drag corresponding to the second thumbnail and a fourth drag corresponding to the second thumbnail, and the method further includes displaying the list on the first display and the second display, simultaneously, displaying an execution screen of an application corresponding to the second thumbnail on the first display according to the third drag on the second display, and ending the application corresponding to the second thumbnail according to the fourth drag on the second display, wherein a direction of the third drag is opposite to a direction of the fourth drag.

Further, a direction of the third drag in the method according to an embodiment is from the second display to the first display, and a direction of the fourth drag is from the first display to the second display.

Further, the drag in the method according to an embodiment includes a fifth drag corresponding to the first thumbnail and a sixth drag corresponding to the second thumbnail, and the fifth drag and the sixth drag cross each other. The method further includes dividing the first display into a first region and a second region according to the fifth drag and the sixth drag.

In addition, the method according to an embodiment further includes displaying an execution screen of an application corresponding to the first thumbnail on the first region according to the fifth drag, and displaying an execution screen of an application corresponding to the second thumbnail on the second region according to the sixth drag, wherein the fifth drag and the sixth drag intersect each other perpendicularly.

In addition, the method further includes displaying the plurality of thumbnails sequentially in a second direction, and according to a seventh drag, displaying an application corresponding to the seventh drag as a most significant application on the first display, wherein the seventh drag corresponds to any one of the plurality of thumbnails, and the second direction is perpendicular to the first direction.

Another embodiment provides a mobile terminal on which a plurality of applications is executed, wherein the mobile terminal includes a display and a controller, wherein the plurality of applications includes a first application and a second application, wherein the controller is configured to divide the display into a first region, a second region, and a third region, display a first thumbnail corresponding to the first application and a second thumbnail corresponding to the second application on the first region, detect a first drag corresponding to the first thumbnail and a second drag corresponding to the second thumbnail, and display an execution screen of an application corresponding to the first thumbnail on the second region according to the first drag, and display an execution screen of an application corresponding to the second thumbnail on the third region according to the second drag.

As described above, according to a mobile terminal, an electronic device having the mobile terminal, and a control method of the electronic device according to the embodiment, with a case having an additional display interworking with the mobile terminal, there may be provided a mobile terminal capable of extending a display area of the mobile terminal, and a case to which the mobile terminal is coupled.

In addition, according to a mobile terminal, an electronic device having the mobile terminal, and a control method of the electronic device according to the embodiment, a display provided on a case can be controlled by wired communication so that the case is compatible with various models and does not need a separate chip for communication.

In addition, according to a mobile terminal, an electronic device having the mobile terminal, and a control method of the electronic device according to the embodiment, applications can be displayed on a plurality of displays by dragging application lists.

In addition, according to a mobile terminal, an electronic device having the mobile terminal, and a control method of the electronic device according to the embodiment, applications can be displayed on a plurality of displays by displaying application lists on the plurality of displays at the same time.

Further, according to a mobile terminal, an electronic device having the mobile terminal, and a control method of the electronic device according to the embodiment, priorities of application lists can be controlled by dragging application lists.

### BRIEF DESCRIPTION OF THE DRAWINGS

FIGS. 1A and 1B are conceptual views illustrating an electronic device according to an embodiment.

FIGS. 2A, 2B, 2C, and 2D are conceptual views illustrating a main structure of an electronic device according to an embodiment.

FIGS. 3A, 3B, and 3C are conceptual views illustrating an example of a mobile terminal related to the present disclosure.

FIG. 4 is a block diagram illustrating a method for controlling between a mobile terminal and a display provided on a case in an electronic device according to an embodiment.

FIG. 5 is a flowchart illustrating a method for controlling between a mobile terminal and a display provided on a case in an electronic device according to an embodiment.

FIGS. 6A, 6B, 6C, and 6D are conceptual views explaining a method for controlling a plurality of displays according to an embodiment and a corresponding method for controlling a memory.

FIGS. 7A and 7B are views illustrating a method for controlling application screens according to another embodiment.

FIG. 7C is a view illustrating an execution screen of a moved application according to an embodiment.

FIGS. 8A and 8B are views illustrating a method for dividing an execution screen of an application by a controller according to an embodiment.

FIG. 9 is a diagram illustrating a method for controlling priorities of lists by a controller according to an embodiment.

FIG. 10 is a flowchart illustrating a method for controlling an electronic device according to an embodiment.

### DETAILED DESCRIPTION OF THE PREFERRED EMBODIMENT

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

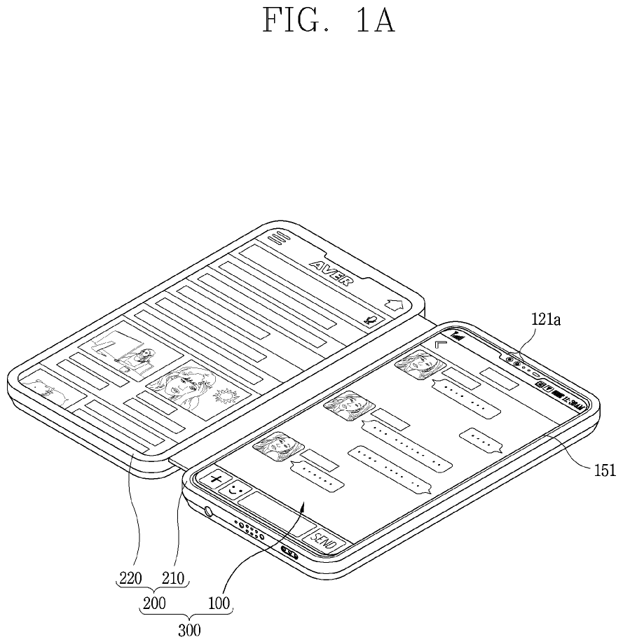

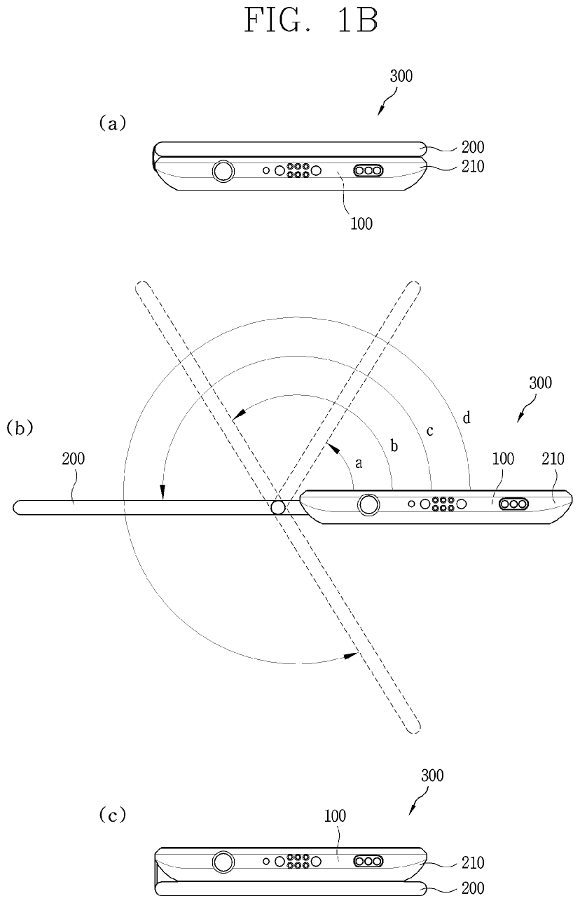

FIGS. 1A and 1B are conceptual views illustrating an electronic device according to an embodiment.

Referring to these drawings, a mobile terminal 100 is coupled to a case 200, and the mobile terminal 100 and the case 200 are combined to configure one electronic device 300.

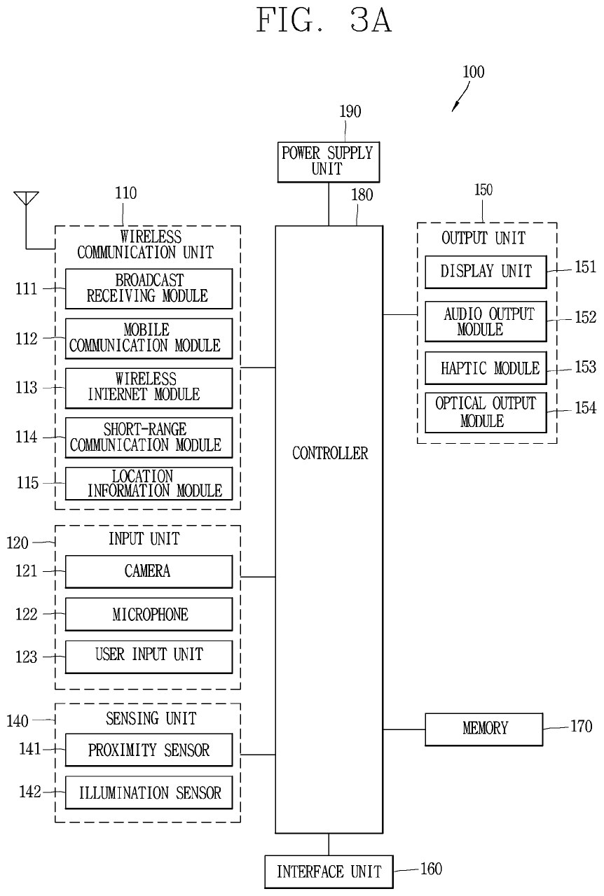

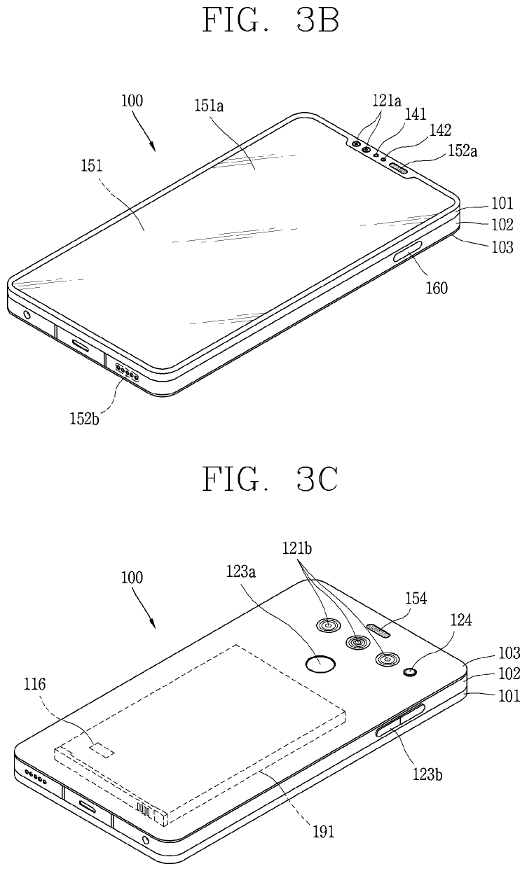

In this case, the mobile terminal may be implemented using a variety of different types of terminals. Examples of such terminals include cellular phones, smart phones, laptop computers, digital broadcast terminals, personal digital assistants (PDAs), portable multimedia players (PMPs), navigators, slate PCs, tablet PCs, ultra books, wearable devices (for example, smart watches, smart glasses, head mounted displays (HMDs)), and the like. Details of the mobile terminal will be described later with reference to FIG. 3.

The case 200 may be a pouch that protects outer surfaces of the mobile terminal 100 or covers or accommodates at least one surface of the mobile terminal 100 as an accessory of the mobile terminal 100. The case 200 may be configured to expand a function of the mobile terminal 100 in combination with the mobile terminal 100.

Meanwhile, in the present disclosure, information output from the mobile terminal may be processed in association with a structure or a function of the case 200. For example, referring to FIG. 1A, the case 200 may include a display (hereinafter, referred to a “second display 250”) cooperating with a display (hereinafter, a “first display 151”) of the mobile terminal. The first display 151 and the second display 250 may be flexible.

The case may include a first body 210 and a second body 220 that are rotatably connected to each other, and may be disposed on any one of the first body 210 and the second body 220.

For example, the first body 210 may be formed to accommodate at least a portion of the mobile terminal body. As a rear side of the mobile terminal is accommodated in the first body 210, and the first display 151 disposed on a front side of the mobile terminal is exposed outside.

In addition, there may be provided at least one hole at one side of the first body 210, so that at least a part of components of the mobile terminal exposed outside the case performs a function when the mobile terminal 100 is coupled to the first body 210.

Here, the mobile terminal 100 may be detachably coupled to the first body 210. In addition, the mobile terminal may be configured to detect whether the mobile terminal is coupled to the first body 210. For the detection, the first body 210 may include a magnet 245 at one side thereof facing the mobile terminal 100, and the mobile terminal may include a hall sensor 143 at the rear side thereof which is configured to sense a magnetic field corresponding to the magnet 245 when the mobile terminal is coupled to the first body. When the magnetic field is sensed by the hall sensor, the mobile terminal may recognize that it is coupled to the case, and then perform predetermined control.

For example, when a magnetic field is sensed by the hall sensor 143, a controller 180 of the mobile terminal 100 may supply action current to the second display 250 provided on the second body 220 or perform a process to prepare a state in which a signal can be transmitted to the second display 250. That is, the predetermined control may refer to an operation related to the preparation process.

Here, the ‘preparation process’ means a standby state in which the controller of the mobile terminal 100 can immediately perform a next process when action current is supplied to the second display 250. Therefore, even if the magnetic field is sensed by the hall sensor 143, a current is not immediately supplied to the second display 250.

Meanwhile, when it is detected that a connector provided at one side of the first body 210, for example, at a lower end of the first body 210 and a connection port provided at a lower end of the mobile terminal accommodated in the first body 210 are mutually coupled, the controller 180 of the mobile terminal may supply action current to the second display 250 provided on the second body 220.

Specifically, action current may be supplied from a power supply of the mobile terminal 100 to a circuit board on the second display 250 through a flexible printed circuit board (FPCB) connected by the connector and a wiring portion (e.g., a coaxial cable) provided in a connection portion 230 of the case 200.

To this end, the controller 180 of the mobile terminal may be configured to recognize resistances Ra and Rd in the first body 210 through a specific contact pin of the connector provided in the first body 210, detect a coupling of the connector and the connection port, and accordingly supply action current. This will be described in more detail below.

The second display 250 provided on the second body 220 may be configured to operate based on power supplied from the mobile terminal 100.

The second display 250 may be disposed on the second body 220 to extend a display area of the first display 151 or may be operated independently of the first display 151. For example, contents related to information outputted on the first display 151 may be mirrored to be outputted on the second display 250.

In addition, execution screens of different applications may be outputted on the first display 151 and the second display 250, respectively. As another example, an execution screen of one application may be divided and outputted on the first display 151 and the second display 250. Also, screens corresponding to different execution steps or different tasks of one application may be outputted on the first display 151 and the second display 250.

Furthermore, the mobile terminal 100 is configured to control screen information outputted on the second display 250, and for this purpose, a communication link for wired communication (e.g., a USB 2.0 communication link) may be established between the mobile terminal 100 and the second display 250.

Meanwhile, both the first display 151 and the second display 250 are exposed outside in open state, and the open state may be defined with reference to FIG. 1B.

Referring to FIG. 1B, the first body 210 and the second body 220 of the case 200 may be relatively rotated between closed state in (a) of FIG. 1B and flipped state in (c) of FIG. 1B.

The closed state is the state in (a) of FIG. 1B, wherein the first body 210 of the case 200 is covering the first display 151 of the mobile terminal 100. Here, the first display 151 is covered by the first body 210. That is, the closed state may be a state in which the first display 151 is covered by the second display 250. In the closed state, the mobile terminal 100 and the case 200 overlap each other in a thickness direction of the mobile terminal, and thus form a diary-like shape, thereby improving user portability.

In the closed state, a body of the mobile terminal 100 accommodated in the first body 210 may not be exposed outside. In addition, in the closed state, a sub-display 250a to display notification information corresponding to a specific event occurring in the mobile terminal 100 may be exposed from one side of a front surface of the second body 220 including the second display 250.

In the closed state, the second body 220 is rotated relative to the first body 210 to be changed to the open state.

The open state is a state in which the first display is not covered by the second display 250, and between the first display 151 and the second display 250 forms a specific angle other than 0 degrees.

Specifically, the open state may be one of a ‘first state’ in which the first display 151 and the second display 250 form about 60 degrees (a), a ‘second state’ in which the first display 151 and the second display 250 form about 120 degrees (b), a ‘third state’ in which the first display 151 and the second display 250 form about 180 degrees (c), and a ‘fourth state’ in which the first display 151 and the second display 250 form about 270 degrees (d), as illustrated in (b) of FIG. 1B.

In the open state, the first body 210 and the second body 220 may be fixed at a specific angle to become any one of the first to fourth states, and a fixing member to fix the bodies at a specific angle may be provided in the second body 220.

The controller 180 of the mobile terminal may control the mobile terminal to perform different operation modes in any one of the first to fourth states. For example, in the first state, the mobile terminal may operate in a ‘privacy protection mode’, and in the second state, the mobile terminal may operate in a ‘laptop mode’. In addition, in the third state, the mobile terminal may operate in a ‘display extension mode’, and in the fourth state, may operate in a ‘multi-display mode’.

A state in which the first display 151 and the second display 250 are exposed outside is defined as the ‘open state’. In the ‘open state’, the first display 151 is not covered by the second display 250. Accordingly, a state in which the first display 151 is covered by the second display 250 is defined as the ‘closed state’. The open state and the closed state may be distinguished by a sensing value of an illuminance sensor provided on a front surface of the first display 151.

Meanwhile, as illustrated in (c) of FIG. 1B, a state in which the first display 151 and the second display 250 relatively rotate to form 360 degrees, so that a rear surface of the first body 210 on which the first display 150 is disposed is completely covered by the a rear surface of the second body 220 on which the second display 250 is disposed may be defined as the ‘flipped state’ in the open state. In the ‘flipped state’, the first display 151 and the second display 250 are exposed outside to face opposite directions to each other.

The flipped state may be detected by recognizing a state in which components (e.g., a rear camera 121b, an optical output module 154, a flash 124, and a user input unit 123) provided on a rear surface of the mobile terminal 100 coupled to the first body 210 are covered by the rear surface of the second body 220.

In addition, the first state to the fourth state, and the flipped state may be detected by a separate sensor provided in the connection portion 230 that couples the first body 210 and the second body 220 to be relatively rotatable or separate sensors provided on the rear surface of the first body 210 and the rear surface of the second body 220.

The electronic device 300 of the present disclosure may perform an operation of controlling the first display 151 and the second display 250 in cooperation with the open state and closed state. As an example, when the first display 151 and the second display 250 are operated in inactive state in the closed state and are changed from the closed state to the open state, at least one of the first display 151 and the second display 250 may be activated.

As an example, when changed to the open state, both the first display 151 and the second display 250 may be changed to active state. Here, different home screen pages may be outputted on the first display 151 and the second display 250, respectively, or identical home screen pages may be displayed on the first display 151 and the second display 250. In addition, various information may be outputted on the first display 151 and the second display 250 according to circumstances.

As another example, when changed to the open state, the first display 151 is switched to active state, and the second display 250 may be maintained in the inactive state.

The second display 250 may include a touch sensor configured to sense a touch applied to the second display 250. Also, the second display 250 may be configured to sense a touch even in the inactive state.

In relation to the touch sensed by the touch sensor, the second display 250 may be operated in active state when a predetermined type of touch is applied to the second display 250 in the open state. Alternatively, the second display 250 may be operated in active state based on a touch applied to the first display 151 in the open state.

Meanwhile, when a touch is applied to the second display 250, the second display 250 may transmit a touch signal corresponding to the touch to the mobile terminal 100. Then, when the touch according to the received touch signal corresponds to a predetermined type of touch, the mobile terminal 100 may transmit a signal corresponding to a control command to activate the second display 250 to the second display 250 side.

Then, the second display 250 and the controller of the second display 250 may be activated based on the signal received from the mobile terminal 100.

The transmission and reception of the signal may be performed by a wired communication method combining the connector provided on one side of the first body 210 and the connection port provided on the mobile terminal 100.

Meanwhile, a structure of the case to implement the operation of the electronic device described above will be described in more detail below.

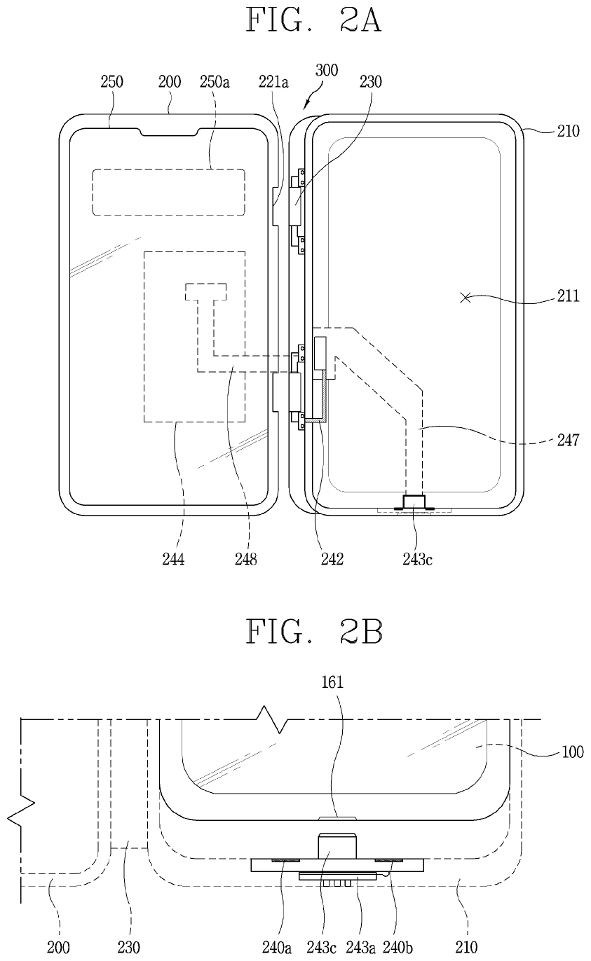

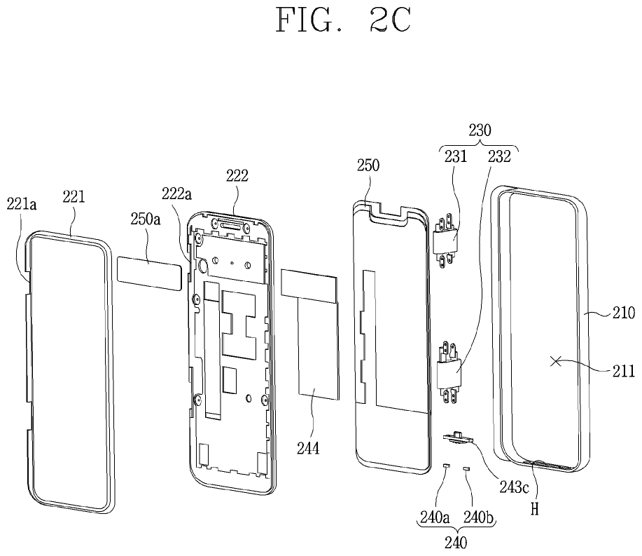

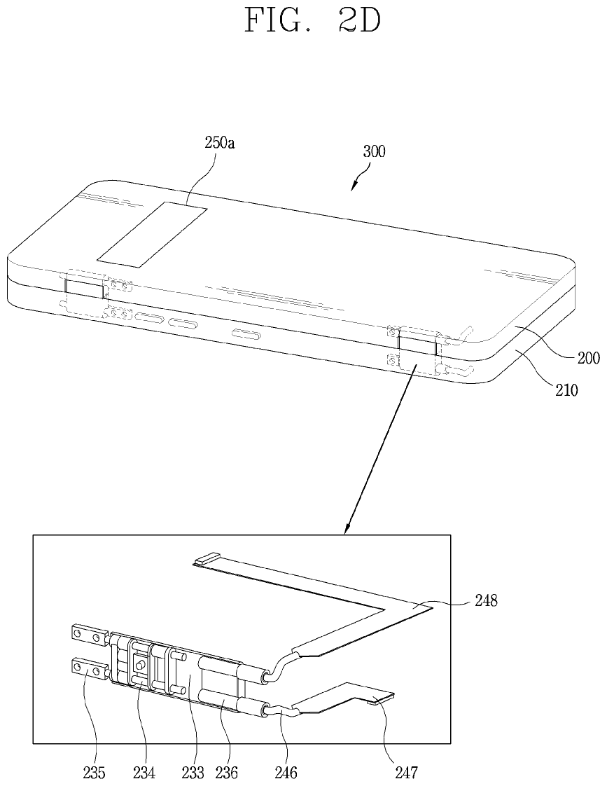

Referring to FIG. 2A, the first body 210 of the case 200 includes an accommodating space 211 configured to accommodate a rear surface of the body of the mobile terminal. The first body accommodates at least a portion of the mobile terminal in the accommodating space 211, and the rear surface of the mobile terminal is disposed on a bottom surface of the accommodating space 211.

The second body 220 on which the second display 250 is disposed is rotatably coupled to the first body by the connection portion 230. That is, the connection portion 230 is disposed between the first body 210 and the second body 220 to couple the first body 210 and the second body 220 so that the first body 210 and the second body 220 are relatively rotatable.

The sub-display 250a to display predetermined information, for example, time information or event notification, may be provided on a front side of the second body 220. In this case, a simple event notification can be immediately checked through the sub-display 250a in the closed state without switching the electronic device 300 to the open state.

Referring to FIGS. 2A to 2D, the second body 220 may include a first cover 221, a second cover 222, and the second display 250. An accommodation groove 221a to accommodate at least a part of the connection portion 230 may be formed in the first cover 221. In addition, the second cover 222 is coupled to the first cover 221, and may be a frame in which various electronic components are mounted. As such an example, a circuit board 248 on the second display 250 side, which will be described later, may be mounted on the second cover 222.

The second cover 222 may be rotatably coupled with the connection portion 230, and a groove 222a may be formed at a position corresponding to the accommodation groove 221a of the first cover 221, and the connection portion 230 may be disposed in the groove 222a. In this case, the second display 250 may be mounted to the second cover 222.

In addition, a signal transmitted from the controller of the mobile terminal is transmitted to the second display 250 side through a wiring portion 242, for example, a coaxial cable, provided on an inner side of the connection portion 230 and connected to a flexible printed circuit board 247 provided on a rear side of the first body 210. Hereinafter, the flexible printed circuit board provided on the rear side of the first body 210 and combined with the wiring portion 242 of the connection portion 230 will be referred to as a ‘first flexible printed circuit board’ 247. In addition, a flexible printed circuit board provided on a rear side of the second body 220 and combined with the wiring portion 242 of the connection portion 230 is referred to as a ‘second flexible printed circuit board’ 248.

The connection portion 230 may include a first hinge 231 and a second hinge 232 spaced apart along a side surface of the first body 210. The first hinge 231 and the second hinge 232 may each include a hinge body 233 and a hinge shaft 234.

A hinge groove (not shown) is formed in the hinge body 233, and the hinge shaft 234 is inserted into the hinge groove so that the first body 210 and the second body 220 can rotate relative to each other. The hinge shaft 234 may be provided in plural, and coupling portions 235 coupled to the first body 210 and the second body 220, respectively, may be disposed on one side of the hinge shaft 234.

In addition, the wiring portion 242, for example, a coaxial cable, to be connected to a first flexible printed circuit board 247 and a second flexible printed circuit board 248 is provided on the inner side of the connection portion 230.

A connector 243a protruded toward the accommodating space 211 accommodating the mobile terminal and inserted into the connection port provided on one side of the mobile terminal body may be disposed on one side of the first body 210. To this end, at least one hole H through which at least a portion of a connector module including the connector 243a penetrates may be formed at one side of the first body 210, for example, a side surface of a lower end.

Although not all illustrated, the connector 243a may be formed to be rotatable 180 degrees toward the outside of the case, or may be formed to be drawn in or out of the case by external force. In this case, even if there exists the connector 243a, the mobile terminal body can be easily accommodated in the first body 210.

Alternatively, in one example, the first body 210 may be detachable in a vertical direction or at least an upper portion of the first body 210 may be made of a flexible material so that the mobile terminal body can be easily accommodated in the first body 210.

The connector module in which the connector 243a is installed may be mounted on one side of the first body 210, for example, at a center of a lower end. The connector 243a may be installed at one end of the connector module, and a charging port having a female pogo pin to be coupled to an external male pin may be installed at another end.

The connector 243a may be connected to a circuit board 244 to control the second display 250 through the first flexible printed circuit board 247, the second flexible printed circuit board 248, and the wiring portion 242. In addition, the connector 243a may be connected to the circuit board 244 through coupling with the connection port of the mobile terminal body. Here, the connection port provided in the mobile terminal body may mean, for example, a USB port.

The second display 250 side performs wired communication with the mobile terminal 100 through the first flexible printed circuit board 247, the second flexible printed circuit board 248, the wiring portion 242, and the circuit board 244 coupled through the connector 243a. In addition, the mobile terminal 100 performs wired communication with the second display 250 side through the connection port connected to the connector 243a. In this regard, the connection port of the mobile terminal 100 may be referred to as a ‘first wired communication unit’, and the connector 243a of the case may be referred to as a ‘second wired communication unit’.

A first wired communication unit 161 and a second wired communication unit 243 may perform USB communication. The first wired communication unit 161 may perform USB I/O communication to transmit a signal to the case side through the second wired communication unit 243.

In addition, the second wired communication unit 243 may perform USB I/O communication to transmit a signal to the mobile terminal through the first wired communication unit 161. Here, the USB I/O communication may refer to USB 2.0 or USB 3.0 communication.

A universal serial bus (USB) is a common connector and is defined as an interface standard that enables connection of various peripheral devices. In the universal serial bus (USB), a host necessarily exists, and communication is performed by a control through the host.

Referring to FIG. 2B, the connector 243a provided at the lower end of the first body 210 of the case and connected to the connection port of the mobile terminal may be mounted on the connector module. One end of the connector 243a is joined to a supporting member of the connector module, and another end of the connector 243a may form a protrusion 243c. The connector 243a is connected to the connection port of the mobile terminal as the protrusion 243c is inserted in a direction from the outside to inside of the mobile terminal.

A plurality of contact pins (e.g., male pins) may be provided inside the connector, and each of the plurality of contact pins may be set to perform a specific function when connected to pins of the connection port of the mobile terminal (e.g., female pins). This will be described in more detail below.

Meanwhile, according to FIG. 2A, the first body 210 is provided with the first flexible printed circuit board 247 connected to the connector 243a. The first flexible printed circuit board 247 may be connected to the circuit board 244 and the second flexible printed circuit board 248 on the second display 250 side via the wiring portion 242 inside the connection portion 230, for example, a coaxial cable.

In this way, the first body 210 does not have a separate circuit board for wireless communication or the like other than the first flexible printed circuit board 247, so that the first body 210 becomes thinner, and the mobile terminal also does not need to have a separate circuit board for wireless communication. Accordingly, a compatibility of the mobile terminal mountable in the case is further improved, and an overall thickness of the electronic device can be fabricated thinner.

According to the drawing, the first body 210 and the second body 220 are coupled to the circuit board 244 via the wiring portion 242 coupled to the first flexible printed circuit board 247 and the second flexible printed circuit board 248, and they are electrically connected to each other. The circuit board 244 may be connected to the second display 250 to transmit a signal received from the mobile terminal 100 to the second display 250.

That is, the circuit board 244 may transmit data transmitted and received from the mobile terminal through the first wired communication unit 161 and the second wired communication unit 243 to the second display 250.

The wiring portion 242 electrically connects the first body 210 and the second body 220 through the connection portion 230. For this connection, a connection passage through which the wiring portion 242 passes may be formed in the connection portion 230.

As an example of this, the first hinge 231 and the second hinge 232 have an accommodating space accommodating at least a part of the wiring portion 242. For example, the wiring portion 242 connected to the first flexible printed circuit board 247 that is coupled with the second wired communication unit 243 may be accommodated in the second hinge 232. In addition, the first hinge 231 and the second hinge 232 may be defined in a mutually symmetrical structure or shape.

The first wired communication unit 161 and the second wired communication unit 243 may be disposed at a lower side of the case 200 and the mobile terminal 100. In this case, the first flexible printed circuit board 247 connected to the wiring portion 242 may also be formed to be connected to one of the first hinge 231 and the second hinge 232 from the lower side.

In addition, the second hinge 232 may include an extending portion 236 extending from the hinge body 233, and the extending portion 236 may include cables 246 extended to the first body 210 and the second body 220, respectively. The accommodating space is formed in the extending portion 236, and the cables 246 are accommodated in the accommodating space. The first flexible printed circuit board 247 and the second flexible printed circuit board 248 are disposed at both ends of the cables 246, and the first flexible printed circuit board 247 and the second flexible printed circuit board 248 are electrically connected to the circuit board 244. According to the structure, a signal controlling the second display 250 is transmitted from the mobile terminal to the first body 210 and the second body 220 through the first wired communication unit 161 and the second wired communication unit 243.

Meanwhile, referring to the drawings, at the lower end of the first body 210 of the case, there may be disposed the connector 243a connected to the connection portion of the mobile terminal so that the second display 250 and the circuit board 244 receive power from the mobile terminal. The connector 243a supplies power of the mobile terminal to the circuit board 244 through the first flexible printed circuit board 247, the wiring portion 242, and the second flexible printed circuit board 248, and the circuit board 244 provides the power to the second display 250.

According to the structure, power supplied to the second display 250 and a signal transmitted to the second display 250 may be transmitted through a wired path in the mobile terminal.

According to the above-described structure, the electronic device performs an operation of interlocking and controlling the first display 151 and the second display 250 by using wired communication and a wired power supply path. Hereinafter, the structure and the function of the mobile terminal will be described first, and then the control operation will be described.

FIGS. 3A, 3B, and 3C are conceptual views illustrating an example of the mobile terminal related to the present disclosure. The mobile terminal 100 according to the embodiment may be coupled to the case of the electronic device described above.

Referring to FIGS. 3A to 3C, FIG. 3A is a block diagram of the mobile terminal in accordance with the present disclosure, and FIGS. 3B and 3C are conceptual views illustrating one example of the mobile terminal, viewed from different directions.

The mobile terminal 100 may be shown having components such as a wireless communication unit 110, an input unit 120, a sensing unit 140, an output unit 150, an interface unit 160, a memory 170, a controller 180, and a power supply 190. It is understood that implementing all of the components illustrated in FIG. 3A is not a requirement, and that greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, or communications between the mobile terminal 100 and an external server. Further, the wireless communication unit 110 may typically include one or more modules which connect the mobile terminal 100 to one or more networks.

The wireless communication unit 110 may include one or more of a broadcast receiver 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and the user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, a red, green, and blue (RGB) sensor, an infrared (IR) sensor, a finger scan sensor, a ultrasonic sensor, an optical sensor (for example, camera 121), a microphone 122, a power supply gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from two or more sensors, and combinations thereof.

The output unit 150 may typically be configured to output various types of information, such as audio, video, tactile output, and the like. The output unit 150 may include at least one of the first display 151, an audio output module 152, a haptic module 153, and the optical output module 154. The first display 151 may have an inter-layered structure or an integrated structure with a touch sensor in order to implement a touch screen. The touch screen may function as the user input unit 123 which provides an input interface between the mobile terminal 100 and the user and simultaneously provide an output interface between the mobile terminal 100 and a user.

The interface unit 160 serves as an interface with various types of external devices that are coupled to the mobile terminal 100. The interface unit 160, for example, may include any of wired or wireless headset ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is implemented to store data to support various functions or features of the mobile terminal 100. For instance, the memory 170 may be configured to store application programs or applications executed in the mobile terminal 100, data or instructions for operations of the mobile terminal 100, and the like. At least one of these application programs may be downloaded from an external server via wireless communication. Other application programs may be installed within the mobile terminal 100 at time of manufacturing or shipping, which is the case for basic functions of the mobile terminal 100 (for example, receiving a call, placing a call, receiving a message, sending a message, and the like). Application programs may be stored in the memory 170, installed in the mobile terminal 100, and executed by the controller 180 to perform an operation (or function) for the mobile terminal 100.

The controller 180 functions to control an overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 3A, to execute an application program that have been stored in the memory 170. In addition, the controller 180 may control at least two of those components included in the mobile terminal 100 to activate the application program.

The power supply 190 may be configured to receive external power or internal power in order to supply appropriate power required for operating elements and components included in the mobile terminal 100, under the control by the controller 180. The power supply 190 may include a power supply, and the power supply may be configured as an embedded power supply or a detachable power supply.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Hereinafter, description will be given in more detail of the aforementioned components with reference to FIG. 3A, prior to describing various embodiments implemented through the mobile terminal 100.

First, regarding the wireless communication unit 110, the broadcast receiver 111 is configured to receive a broadcast signal and/or broadcast associated information from an external broadcast managing server via a broadcast channel. The broadcast channel may include a satellite channel, a terrestrial channel, or both. Two or more broadcast receiving modules may be provided to the mobile terminal 100 to facilitate simultaneous reception of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The radio signal may include various types of data depending on a voice call signal, a video call signal, or a text/multimedia message transmission/reception.

The wireless Internet module 113 refers to a module for wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area network.

Here, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position (or current position) of the mobile terminal. As an example, the location information module 115 includes a Global Position System (GPS) module, a Wi-Fi module, or both. For example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If desired, the location information module 115 may alternatively or additionally function with any of the other modules of the wireless communicator 110 to obtain data related to the position of the mobile terminal. The location information module 115 is a module used for acquiring the position (or the current position) and may not be limited to a module for directly calculating or acquiring the position of the mobile terminal.

Next, the input unit 120 is for inputting image information (or signal), audio information (or signal), data, or information input from a user. For inputting image information, the mobile terminal 100 may be provided with a plurality of cameras 121. Such cameras 121 may process image frames of still pictures or video obtained by image sensors in a video call or image capture mode. The processed image frames can be displayed on the first display 151 or stored in the memory 170. Meanwhile, the cameras 121 may be arranged in a matrix configuration to permit a plurality of images having various angles or focal points to be input to the mobile terminal 100. Also, the cameras 121 may be located in a stereoscopic arrangement to acquire left and right images for implementing a stereoscopic image.

The microphone 122 processes an external audio signal into electric audio (sound) data. The processed audio data can be processed in various manners according to a function executed in the mobile terminal 100. The microphone 122 may include assorted noise removing algorithms to remove unwanted noise generated in the course of receiving the external audio signal.

The user input unit 123 is a component that receives an input of information from a user. Such user input may enable the controller 180 to control operation of the mobile terminal 100 in correspondence with the received information. The user input unit 123 may include one or more of a mechanical input element (for example, a mechanical key, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like, and generate a corresponding sensing signal. The controller 180 generally cooperates with the sending unit 140 to control operations of the mobile terminal 100 or execute data processing, a function or an operation associated with an application program installed in the mobile terminal based on the sensing signal. The sensing unit 140 may be implemented using any of a variety of sensors, some of which will now be described in more detail.

The proximity sensor 141 refers to a sensor to sense presence or absence of an object approaching a surface, or an object existing near a surface, by using an electromagnetic field, infrared light, or the like without a mechanical contact. The proximity sensor 141 may be arranged at an inner area of the mobile terminal covered by the touch screen, or near the touch screen.

When the touch screen is implemented as a capacitance type, the proximity sensor 141 can sense proximity of a pointer relative to the touch screen by changes of an electromagnetic field, which is responsive to an approach of an object with conductivity. When the touch screen is implemented as a capacitance type, the proximity sensor 141 may sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data (or information) according to whether a touch with respect to a point on the touch screen is either a proximity touch or a contact touch.

A touch sensor may sense a touch (or a touch input) applied to the touch screen, such as the first display 151, using any of a variety of touch methods. Examples of such touch methods include a resistive type, a capacitive type, an infrared type, and a magnetic field type, among others.

As one example, the touch sensor may be configured to convert changes of pressure applied to a specific part of the first display 151, or convert capacitance occurring at a specific part of the first display 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which area of the first display 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

Meanwhile, the touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The first display 151 displays (or outputs) information processed in the mobile terminal 100. For example, the first display 151 may display execution screen information of an application program executing at the mobile terminal 100 or user interface (UI) and graphic user interface (GUI) information in response to the execution screen information.

Also, the first display 151 may be implemented as a stereoscopic display for displaying stereoscopic images.

A typical stereoscopic display may employ a stereoscopic display scheme such as a stereoscopic scheme (a glass scheme), an auto-stereoscopic scheme (glassless scheme), a projection scheme (holographic scheme), or the like.

The audio output module 152 may receive audio data from the wireless communication unit 110 or output audio data stored in the memory 170 during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

The optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal therethrough. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control operations relating to application programs and the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 may control one or a combination of those components in order to implement various exemplary embodiments disclosed herein on the mobile terminal 100 according to the present disclosure.

The power supply 190 may receive external power or internal power and supply appropriate power required for operating respective elements and components under the control of the controller 180. The power supply 190 may include a power supply, which is typically rechargeable or be detachably coupled to the terminal body for charging.

The power supply 190 may include a connection port. The connection port may be configured as one example of the interface unit 160 to which an external charger for supplying power to recharge the power supply is electrically connected.

As another example, the power supply 190 may be configured to recharge the power supply in a wireless manner without use of the connection port. In this example, the power supply 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring to FIGS. 3B and 3C, the disclosed mobile terminal 100 includes a bar-like terminal body. However, the mobile terminal 100 may alternatively be implemented in any of a variety of different configurations. Examples of such configurations include watch type, clip-type, glasses-type, or a folder-type, flip-type, slide-type, swing-type, and swivel-type in which two and more bodies are combined with each other in a relatively movable manner, and combinations thereof. Discussion herein will often relate to a particular type of mobile terminal. However, such teachings with regard to a particular type of mobile terminal will generally apply to other types of mobile terminals as well.

Here, considering the mobile terminal 100 as at least one assembly, the terminal body may be understood as a conception referring to the assembly.

The mobile terminal 100 will generally include a case (for example, frame, housing, cover, and the like) forming an appearance of the terminal. In this embodiment, the case is formed using a front case 101 and a rear case 102. Various electronic components are interposed into a space formed between the front case 101 and the rear case 102. At least one middle case may be additionally positioned between the front case 101 and the rear case 102.

The first display 151 is located on a front surface of the terminal body to output information. As illustrated, a window 151a of the first display 151 may be mounted in the front case 101 to form a front surface of the terminal body together with the front case 101.

In some embodiments, electronic components may also be mounted in the rear case 102. Examples of such electronic components include a detachable power supply 191, an identification module, a memory card, and the like. In this case, a rear cover 103 is shown covering the electronic components, and this cover may be detachably coupled to the rear case 102. Therefore, when the rear cover 103 is detached from the rear case 102, the electronic components mounted in the rear case 102 are exposed to the outside.

As illustrated, when the rear cover 103 is coupled to the rear case 102, a side surface of the rear case 102 may partially be exposed. In some cases, upon the coupling, the rear case 102 may also be completely shielded by the rear cover 103. Meanwhile, the rear cover 103 may include an opening for externally exposing a camera 121b, the optical output module 154, the flash 124, a rear input unit, or the likes.

The cases 101, 102, and 103 may be formed by injection-molding synthetic resin or may be formed of a metal, for example, stainless steel (STS), aluminum (Al), titanium (Ti), or the like.

As an alternative to the example in which the plurality of cases forms an inner space for accommodating components, the mobile terminal 100 may be configured such that one case forms the inner space. In this case, a mobile terminal 100 having a uni-body is formed in such a manner that synthetic resin or metal extends from a side surface to a rear surface.

Meanwhile, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display 151, first and second audio output module 152a and 152b, a proximity sensor 141, an illumination sensor 142, the optical output module 154, first and second cameras 121a and 121b, first and second manipulation units 123a and 123b, a microphone 122, an interface unit 160, and the like.

Hereinafter, as illustrated in FIGS. 3B and 3C, description will be given of the exemplary mobile terminal 100 in which the front surface of the terminal body is shown having the first display 151, the first audio output module 152a, the proximity sensor 141, the illumination sensor 142, and the first camera 121a, the side surface of the terminal body is shown having the second manipulation unit 123b, the second audio output module 152b, the microphone 122, and the interface unit 160, and the rear surface of the terminal body is shown having the optical output module 154, the manipulation unit 123a, the second camera 121b, and the flash 124.

However, those components may not be limited to the arrangement. Some components may be omitted or rearranged or located on different surfaces. For example, the manipulation unit may not be located on the front surface of the terminal body, and the second audio output module 152b may be located on the rear surface of the terminal body other than the side surface of the terminal body.

The first display 151 displays (or outputs) information processed in the mobile terminal 100. For example, the first display 151 may display execution screen information of an application program executing at the mobile terminal 100 or user interface (UI) and graphic user interface (GUI) information in response to the execution screen information.

The first display 151 may include at least one of a liquid crystal display (LCD), a thin film transistor-LCD (TFT LCD), an organic light-emitting diode (OLED), a flexible display, a three-dimensional (3D) display and an e-ink display.

The first display 151 may be implemented using two display devices, according to the configuration type thereof. For instance, the mobile terminal 100 may be provided with a plurality of displays of disposed on one surface in a spaced or integrated manner, or on different surfaces from each other.

The first display 151 may include a touch sensor that senses a touch with respect to the first display 151 so as to receive a control command in a touch manner. Accordingly, when a touch is applied to the first display 151, the touch sensor may sense the touch, and the controller 180 may generate a control command corresponding to the touch. Contents input in the touch manner may be characters, numbers, instructions in various modes, or a menu item that can be specified.

On the other hand, the touch sensor may be configured in a form of a film having a touch pattern and disposed between the window 151a and a display (not illustrated) on a rear surface of the window, or may be a metal wire directly patterned on the rear surface of the window. Alternatively, the touch sensor may be formed integrally with the display. For example, the touch sensor may be disposed on a substrate of the display, or may be provided inside the display.

In this way, the first display 151 may form a touch screen together with the touch sensor, and in this case, the touch screen may function as the user input unit (123, see FIG. 3A). In some cases, the touch screen may replace at least some of functions of the manipulation unit.

The first audio output module 152a may be implemented as a receiver for transmitting a call sound to a user's ear and the second audio output module 152b may be implemented as a loud speaker for outputting various alarm sounds or multimedia reproduction request sounds.

The window 151a of the first display 151 may include a sound hole for emitting sounds generated from the first audio output module 152a. However, the present disclosure is not limited thereto, and the sounds may be released along an assembly gap between the structural bodies (for example, a gap between the window 151a and the front case 101). In this case, a hole independently formed to output audio sounds may not be seen or may otherwise be hidden in terms of appearance, thereby further simplifying the appearance of the mobile terminal 100.

The optical output module 154 may be configured to output light for indicating an event generation. Examples of such events may include a message reception, a call signal reception, a missed call, an alarm, a schedule alarm, an email reception, information reception through an application, and the like. When a user has checked a generated event, the controller 180 may control the optical output module 154 to stop the light output.

The first camera 121a may process image frames such as still or moving images obtained by the image sensor in a capture mode or a video call mode. The processed image frames can then be displayed on the first display 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion. The first and second manipulation units 123a and 123b may employ any method when it is a tactile manner allowing the user to perform manipulation with a tactile feeling such as touch, push, scroll or the like. The first and second manipulation units 123a and 123b may also be manipulated through a proximity touch, a hovering touch, and the like, without a user's tactile feeling.

The first manipulation unit 123a may be configured with a mechanical key, or a combination of a touch key and a push key. In addition, the first manipulation unit 123a may be configured in a layered form with a fingerprint sensor.

The content received by the first and second manipulation units 123a and 123b may be set in various ways. For example, the first manipulation unit 123a may be used by the user to input a command such as menu, home key, cancel, search, or the like, and the second manipulation unit 123b may be used by the user to input a command, such as controlling a volume level being output from the first or second audio output module 152a or 152b, switching into a touch recognition mode of the first display 151, or the like.

On the other hand, as another example of the user input unit 123, the rear input unit (not shown) may be disposed on the rear surface of the terminal body. The rear input unit may be manipulated by a user to input a command for controlling an operation of the mobile terminal 100. The content input may be set in various ways. For example, the rear input unit may be used by the user to input a command, such as power on/off, start, end, scroll or the like, controlling a volume level being output from the first or second audio output module 152a or 152b, switching into a touch recognition mode of the first display 151, or the like. The rear input unit may be implemented into a form allowing a touch input, a push input or a combination thereof.

The rear input unit may be disposed to overlap the first display 151 of the front surface in a thickness direction of the terminal body. As one example, the rear input unit may be disposed on an upper end portion of the rear surface of the terminal body such that a user can easily manipulate it using a forefinger when the user grabs the terminal body with one hand. However, the present disclosure may not be limited to this, and the position of the rear input unit may be changeable.

When the rear input unit is disposed on the rear surface of the terminal body, a new user interface may be implemented using the rear input unit. Also, the aforementioned touch screen or the rear input unit may substitute for at least some of functions of the first manipulation unit 123a located on the front surface of the terminal body. Accordingly, when the first manipulation unit 123a is not disposed on the front surface of the terminal body, the first display 151 may be implemented to have a larger screen.

On the other hand, the mobile terminal 100 may include a finger scan sensor which scans a user's fingerprint. The controller 180 may use fingerprint information sensed by the finger scan sensor as an authentication means. The finger scan sensor may be installed in the first display 151 or the user input unit 123.

The microphone 122 may be configured to receive the user's voice, other sounds, and the like. The microphone 122 may be provided at a plurality of places, and configured to receive stereo sounds.

The interface unit 160 may serve as a path allowing the mobile terminal 100 to interface with external devices. For example, the interface unit 160 may be at least one of a connection terminal for connecting to another device (for example, an earphone, an external speaker, another display), a port for near field communication (for example, an Infrared DaAssociation (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b may be further mounted to the rear surface of the terminal body. The second camera 121b may have an image capturing direction, which is substantially opposite to the direction of the first camera unit 121a.

The second camera 121b may include a plurality of lenses arranged along at least one line. The plurality of lenses may be arranged in a matrix form. The cameras may be referred to as an ‘array camera.’ When the second camera 121b is implemented as the array camera, images may be captured in various manners using the plurality of lenses and images with better qualities may be obtained.

The flash 124 may be disposed adjacent to the second camera 121b. When an image of a subject is captured with the second camera 121b, the flash 124 may illuminate the subject.

The second audio output module 152b may further be disposed on the terminal body. The second audio output module 152b may implement stereophonic sound functions in conjunction with the first audio output module 152a, and may be also used for implementing a speaker phone mode for call communication.

At least one antenna for wireless communication may be disposed on the terminal body. The antenna may be embedded in the terminal body or formed in the case. For example, an antenna which configures a part of the broadcast receiving module 111 (see FIG. 3A) may be retractable into the terminal body. Alternatively, an antenna may be formed in a form of film to be attached onto an inner surface of the rear cover 103 or a case including a conductive material may serve as an antenna.

The terminal body is provided with the power supply 190 (see FIG. 3A) for supplying power to the mobile terminal 100. The power supply 190 may include the power supply 191 which is mounted in the terminal body or detachably coupled to an outside of the terminal body.

The power supply 191 may receive power via a power cable connected to the interface unit 160. Also, the power supply 191 may be (re)chargeable in a wireless manner using a wireless charger. The wireless charging may be implemented by magnetic induction or electromagnetic resonance.

Meanwhile, the drawing illustrates that the rear cover 103 is coupled to the rear case 102 for shielding the power supply 191, so as to prevent separation of the power supply 191 and protect the power supply 191 from an external impact or foreign materials. When the power supply 191 is detachable from the terminal body, the rear case 103 may be detachably coupled to the rear case 102.

An accessory for protecting an appearance or assisting or extending the functions of the mobile terminal 100 may further be provided on the mobile terminal 100. As one example of the accessory, a cover or pouch for covering or accommodating at least one surface of the mobile terminal 100 may be provided. The cover or pouch may cooperate with the first display 151 to extend the function of the mobile terminal 100. Another example of the accessory may be a touch pen for assisting or extending a touch input onto a touch screen.

Meanwhile, the electronic device according to the embodiment is configured, such that the connection port of the interface unit 160 provided on one side (e.g., lower end of side surface) of the mobile terminal, that is, the first wired communication unit 161 and the connector provided at one side of the first body 210 of the case 200, i.e., the second wired communication unit 243 are combined together to supply power and to perform wired communication for transmission and reception of various signals.

Here, it has been described that the wired communication is performed using a USB I/O interface standard. However, it is not limited thereto, and it should be noted that other interface standards for wired communication may be applied.

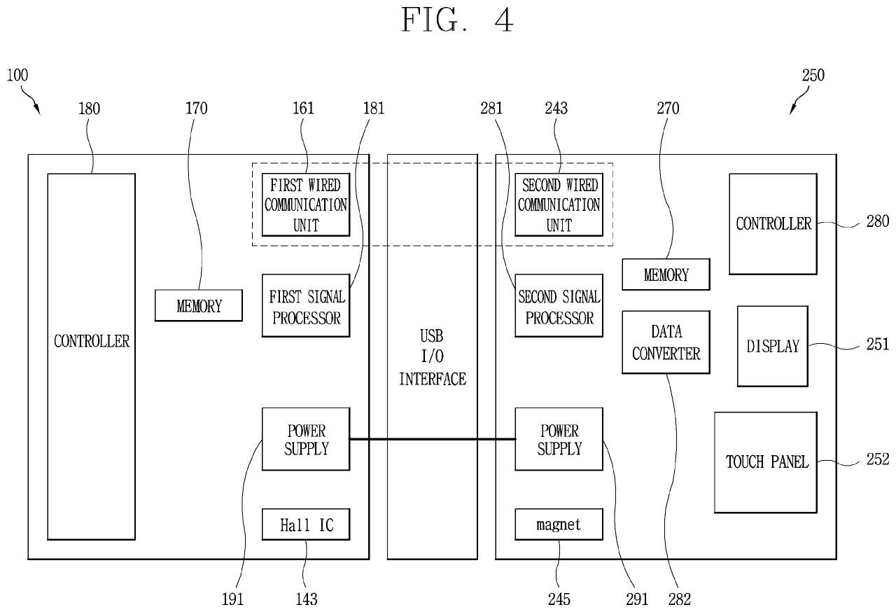

Hereinafter, a method for performing wired communication between the first wired communication unit 161 and the second wired communication unit 243 will be described in more detail with reference to the accompanying drawings. FIG. 4 is a conceptual view illustrating a method for controlling between the mobile terminal and the display provided in the case in the electronic device according to an embodiment.

The mobile terminal 100 according to an embodiment may be coupled to the first body 210, and when the mobile terminal 100 is coupled to the first body 210, the connector 243a provided in the first body 210 is inserted into the connection port provided in the mobile terminal 100, and wired communication may be performed through the first wired communication unit 161 and the second wired communication unit 243.

At this time, the first body 210 on the case side becomes a host device of the mobile terminal, and may perform wired communication, for example, USB communication, with the mobile terminal 100.

The first wired communication unit 161 provided in the mobile terminal 100 may be included in the interface unit 160 described with reference to FIG. 3A. The interface unit 160 includes a plurality of contact pins, and is configured to identify a host device connected to the contact pins by the controller 180 of the mobile terminal.

The first wired communication unit 161 may be provided on a side surface of the lower end of the mobile terminal 100. In addition, the second wired communication unit 243 may be provided to correspond to a position in contact with the first wired communication unit 161 when the mobile terminal 100 is accommodated in the first body 210 of the case. That is, the second wired communication unit 243 may be provided on a side surface of the lower end of the first body 210.

In the present disclosure, when the mobile terminal 100 is accommodated in the first body 210, and the connector pin of the second wired communication unit 243 provided in the first body 210 is inserted into the port of the first wired communication unit 161 of the mobile terminal, wired communication, for example, USB I/O communication, may be performed through the first wired communication unit 161 and the second wired communication unit 243.

Accordingly, the mobile terminal 100 may supply action current to the second display 250 through the USB I/O interface, and transmit a control signal or an image signal. Also, in the second display 250, a touch signal may be transmitted to the mobile terminal 100 through the USB I/O interface to process the touch signal corresponding to the touch input applied to the second display 250.

Meanwhile, supply of the above-described action current and transmission of the control signal and the image signal may be performed through different wired communication paths. To this end, the first wired communication unit 161 and the second wired communication unit 243 may include a plurality of connector pins, and may be set to use different contact pins according to the type of the transmitted signal.

Since the second wired communication unit 243 is inserted into the first wired communication unit 161 and coupled to the case, a plurality of contact pins molded in the second wired communication unit 243 is exposed to the outside. In the present disclosure, a structure in which the plurality of contact pins includes, for example, 12 pins has been described as an example.

Meanwhile, although not illustrated, the first wired communication unit 161 and the second wired communication unit 243 may have a waterproof member (not illustrated) molded together with the plurality of contact pins to prevent fluid from outside or to prevent fluid from moving inside. In addition, the waterproof member may be replaced with an O-ring having an elastic force.

The second wired communication unit 243 provided in the first body 210 is configured to transmit and receive wired data from the mobile terminal to the second display 250 through the wiring portion 242 included in the connection portion 230. In addition, the second wired communication unit 243 may communicate with the first wired communication unit 161 to perform unidirectional communication (data flow from the mobile terminal 100 to the second display 250) or bidirectional communication (bidirectional data flow between the mobile terminal 100 and the second display 150).

The first wired communication unit 161 and the second wired communication unit 243 according to the embodiment may include a contact-type connector method. For example, a USB-C type connector or a lightning cable method may be included.

In addition, the first wired communication unit 161 and the second wired communication unit 243 may be configured to transmit and receive various types of data in a wired communication method. For example, it may be one of graphic data, audio data, video data, touch event data, data related to control, and combinations thereof.

Meanwhile, the second display 250 provided in the second body 220 may be configured to operate based on power supplied from the power supply 191 of the mobile terminal 100.

Here, the power may be transmitted to the second display 250 and the circuit board 244 provided on the second body 220, through the connector 243a connected to the connection port of the mobile terminal 100, the wiring portion 242 coupled to the first flexible printed circuit board 247 and provided in the connection portion 230, and the second flexible printed circuit board 248, as described above.

The power supply 191 of the mobile terminal 100 is configured to supply action current (or power) to a power supply 291 of the second display 250 through electric connection passages of the first wired communication unit 161 connected to the connection port, the first flexible printed circuit board 247, the wiring portion 242 provided in the connection portion 230, and the second flexible printed circuit board 248 provided in the second body 220. Here, the action current is supplied to the second display 250 through a specific contact pin provided in the first wired communication unit 161, for example, a ‘CC1’ pin of a USB C-type.

Meanwhile, the mobile terminal 100 may be detachably coupled to the first body 210. In addition, the mobile terminal may be configured to detect whether the mobile terminal is coupled to the first body 210. For the detection, the first body 210 may include a magnet 245 at one side thereof facing the mobile terminal 100, and the mobile terminal may include a hall sensor 143 at the rear side thereof which is configured to sense a magnetic field corresponding to the magnet 245 when the mobile terminal is coupled to the first body. When the magnetic field is sensed by the hall sensor, the mobile terminal may recognize that the mobile terminal is coupled to the case, and perform predetermined control.

Here, the predetermined control does not mean supplying action current as described above.

When the first wired communication unit 161 and the second wired communication unit 243 are connected to enable mutual communication, the mobile terminal 100 may recognize a plurality of resistances Ra and Rd formed in the first body 210 by specific contact pins (e.g., CC1 and CC2) among a plurality of contact pins included in the first wired communication unit 161 provided in the first body 210. When the plurality of resistances are recognized as described above, action current is supplied to the second display 250 by supplying the power, for example, Vconn to CC1.

When action current is supplied to the second display 250, a system of the second display 250 is booted and initialized, and becomes an operable standby state.

Here, the second display 250 is either in active state or in inactive state, and even when the second display 250 is inactive, a touch sensor (or a touch panel 252) provided in the second display 250 is operated in active state to sense a touch applied to the second display 250.

On the other hand, when the second display 250 is activated, the controller of the mobile terminal 100 transmits an image signal corresponding to screen information to be displayed on the display 251 provided on the second display 250 to the second wired communication unit 243 side through the first wired communication unit 161. Here, a wired communication path of the image signal is different from the wired communication path for supplying power.

For example, the power may be supplied to the second display 250 through a wired communication path through the CC1 pin provided in the second wired communication unit 243, and the image signal may be transmitted to the second display 250 through a wired communication path through the USB SS1 and SS2 pins.

Data may be received from the first wired communication unit 161 to the second display 250 through the second wired communication unit 243 and the circuit board 244. Here, a digital image signal may convert the data into a form that can be outputted on the second display 250 through a data converter 282. For example, the second display 250 may be configured as an LCD panel. And here, the digital image signal of a DP format received from the mobile terminal 100 may be converted into a data format (MIPI format) that can be received on the LCD panel through the data converter 282 to be transferred and outputted on the display 251.

Meanwhile, data transmitted and received through the first wired communication unit 161 and the second wired communication unit 243 may be transmitted and received using different contact pins in the USB I/O interface according to a type of the data.

Specifically, for example, the image signal may be transmitted and received from the mobile terminal 100 to the second display 250 through a USB SSPHY pin, and may be converted into a format that can be outputted on the second display 250 (e.g., MIPI format) through the data converter 282. In addition, for example, a control signal related to the operation of the second display 250 may be transmitted and received to the second display 250 through an external display port (EDP) AUX pin.

Signals that need to be transmitted between the mobile terminal 100 and the display 250, such as communication control signals, touch signals, and brightness control signals, can be transmitted and received through a first signal processor 181 and a second signal processor 281 using a second USB human interface device (HID) communication.

Here, in the mobile terminal 100 in an initial state, the first signal processor 181 transmits and receives signals through the first USB communication by using A6 and A7 pins on an A side, and B6 and B7 pins on a B side of the connector. Meanwhile, the first wired communication unit 161 and the second wired communication unit 234 are connected to enable mutual communication, and when a plurality of resistances Ra and Rd is recognized through the CC1 pin, they are switched by switches and the A side pins and B side pins used in the initial state are separated to transmit and receive signals by using the second USB communication only using B6 and B7 on the B side.

As described above, when switches are switched to process signals by using the second USB communication, the first signal processor 181 and the second signal processor 281 may perform 12c conversion by USB human interface device (HID) communication to perform an operation corresponding to a touch applied to the second display 250, for example, transmission of a touch signal corresponding to the touch. Also, the first signal processor 181 and the second signal processor 281 may support hot plug detect (HPD) communication between the controller 280 and the data converter 282 through the second USB communication.

Meanwhile, initialization of the second display 250 may be controlled by the controller 280 included in the second display 250.

As aforementioned, the mobile terminal according to the embodiment may control information outputted on the display 250 provided in the case 200. That is, the operation of the second display 250 may be controlled by the mobile terminal 100. To this end, the case 200 to which the mobile terminal is coupled may be identified when the connection port of the mobile terminal and the connector provided in the case 200 are connected and a plurality of resistances are recognized. Therefore, since there is no need to provide a separate chip for communication between the mobile terminal and the case 200 in the present disclosure, the case 200 is compatible with various models of mobile terminals, cost can be saved, and a thickness of the case 200 can be thinner.

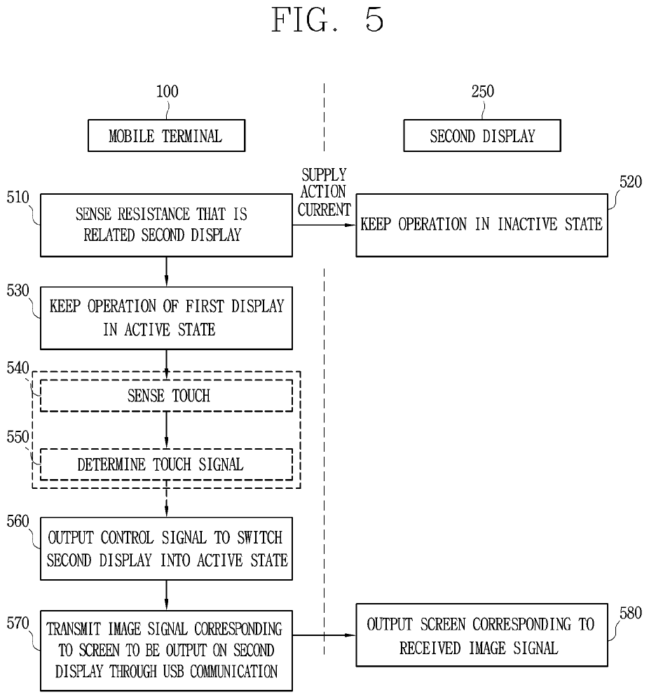

Hereinafter, a control method between the mobile terminal and the display provided in the case will be described in more detail with reference to the accompanying drawings, based on the above descriptions. FIG. 5 is a representative flowchart illustrating a method for controlling between a mobile terminal and a display provided on a case in an electronic device according to an embodiment.

As described above, in an electronic device 300 according to the embodiment, when the mobile terminal 100 is coupled to the case 200, the mobile terminal 100 can sense a resistance corresponding to the second display 250 [510].

Specifically, when the connection port of the mobile terminal 100 is connected to the connector provided on one side of the case 200, the mobile terminal 100 may recognize a plurality of resistances provided with the connector to determine whether to supply action current to the second display 250.

When the plurality of resistances is recognized, action current is supplied from the mobile terminal 100 to the second display 250 through the connector, and the second display 250 can maintain an operation in the inactive state [520].

Specifically, when the plurality of resistances is recognized, the mobile terminal 100 operates in a host mode to supply the action current to the connector in a downstream manner. That is, the connection port of the mobile terminal 100 is switched to be a downstream facing port (DFP) to supply action current to the contact pin. For example, action current is supplied in a form of Vconn power through the CC1 pin among the contact pins of the connector.

In this case, the second display 250 on the case 200 side operates in a device mode to receive the action current in an upstream manner. That is, the connector of the case 200 is operated as an upstream facing port (UFP).

As described above, the action current supplied through the CC1 pin of the connector is supplied to the circuit board 244 or the likes of the second display 250 through the wiring portion 242 coupled to the first flexible printed circuit board 247 and the second flexible printed circuit board 248 as described above. In addition, action current is also supplied to the power supply 291 of the second display 250.

Meanwhile, as described above, the electronic device 300 may be either in an open state and a closed state, and when a transition from the closed state to the open state is detected, the first display 151 provided in the mobile terminal may maintain the operation in the active state [530]. At this time, the transition from the closed state to the open state may be detected by recognizing a sensing value of the illuminance sensor provided on the front side of the mobile terminal 100, for example.

Alternatively, even when the connection port of the mobile terminal 100 is connected to the connector provided on one side of the case 200, and an input is applied to the first display 151 or the user input unit 123 in a state where the electronic device 300 is in the open state, the first display 151 may maintain the operation in the active state.

As described above, when a predetermined touch input is applied to the first display 151 while the second display 250 is maintained in the inactive state, the mobile terminal detects such a touch [540] and determines a touch signal corresponding to the detected touch [550].

When the touch signal is for switching the second display 250 into active state as a result of the determination, the controller of the mobile terminal may output a control signal for switching the second display 250 into the active state [560].

As another example, when a transition of the electronic device 300 from the closed state to the open state is detected and accordingly the first display 151 provided in the mobile terminal is operated in active state, the second display 250 may be operated in a state switched from inactive state to active state after a predetermined time (e.g., 0.5 second to 1 second) has elapsed. That is, a screen of the second display 250 may be turned on. after a predetermined time has elapsed after a screen of the first display 151 was turned on.

In this case, the above-described steps 540 and 550 are omitted, a step of detecting whether the electronic device 300 is switched from the closed state to the open state may be added before performing the step of operating the first display 151 in active state [530].

Meanwhile, as another example, although not illustrated, when a preset touch input is applied to the second display 250 while the second display 250 is operating in inactive state, a control signal to switch the second display 250 to active state may be transmitted from the mobile terminal 100.

In this case, signal processing corresponding to the touch signal sensed by the second display 250 may be performed by the first signal processor 181 and the second signal processor 281 as described above.

Specifically, the mobile terminal 100 performs wired communication in an initial state by using the first USB communication, then when the mobile terminal 100 is connected to the connector of the case 200 and recognizes the plurality of resistances Ra and Rd corresponding to the second display 250, the mobile terminal 100 controls the operation corresponding to the touch by using the second USB communication connected only with the B side contact pins (e.g., B6 and B7).

Even when the second display 250 is deactivated, the touch sensor (or touch panel 252) provided in the second display 250 is operated in active state to sense a touch applied to the second display 250.

The sensed touch may be I2c converted through the first signal processor 181 and the second signal processor 281. In addition, the sensed touch is transferred from the second display 250 to the mobile terminal 100 via the circuit board 244 provided on the second body of the case, the wiring portion 242 coupled with the first flexible printed circuit board 247 and the second flexible printed circuit board 248, and the connector, that is, the second wired communication unit 243.

Then, the mobile terminal 100 determines the touch signal transmitted from the second display 250 as described above, and determines whether the touch signal corresponds to a preset touch input. Here, the preset touch input may refer to, for example, applying a plurality of tabs on the second display 250 in inactive state.

When the touch signal is determined to correspond to the preset touch input, the mobile terminal 100 may perform the process of step 560 described above. That is, a control signal to switch the second display 250 to active state is output by the controller of the mobile terminal 100 and may be transmitted to the second display 250.

Thereafter, the mobile terminal 100 may transmit an image signal corresponding to a screen to be outputted on the second display 250 via USB communication [570].

To this end, the first wired communication unit 161 and the second wired communication unit 243 transmit, for example, the DP type image signal through a USB SS PHY pin. Specifically, the DP type image signal passes through the wiring portion 242 coupled with the first flexible printed circuit board 247 and the second flexible printed circuit board 248 after passing through the first wired communication unit 161 and the second wired communication unit 243 interconnected to each other, is converted to MIPI format by the data converter 282 of the second display 250, and is transferred to the second display 250.

Next, the second display 250 may display a screen corresponding to the received signal, that is, an image signal converted to MIPI format [580]. Here, a type of the screen displayed on the second display 250 is not particularly limited. For example, it may be a home screen page different from a home screen page displayed on the first display 151 or an execution screen of a preset application.

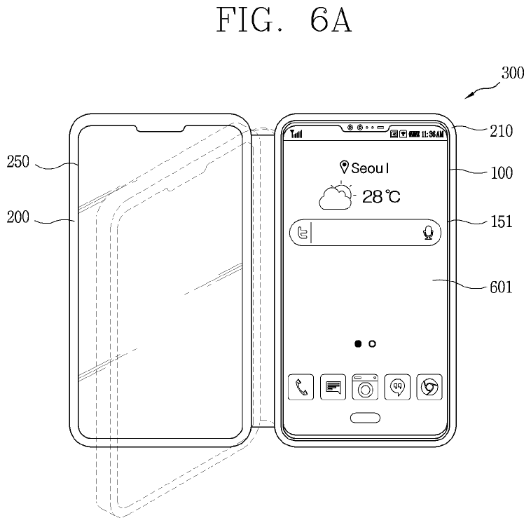

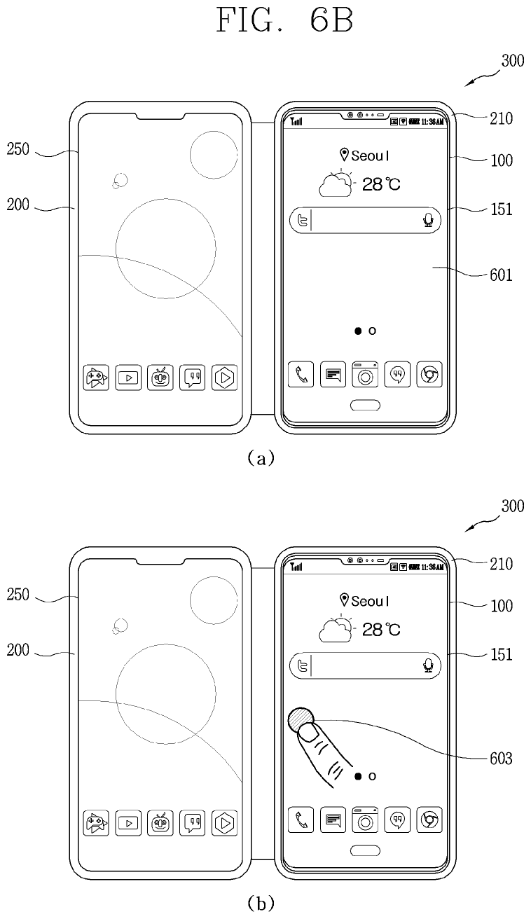

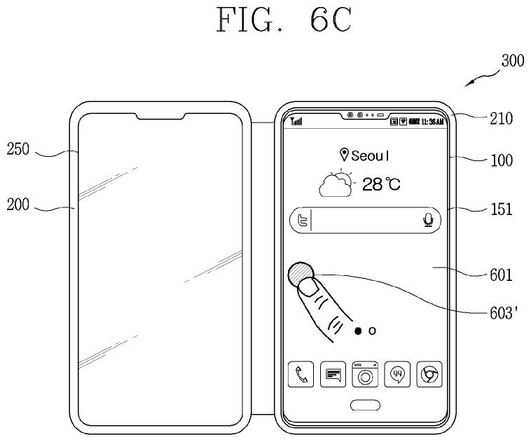

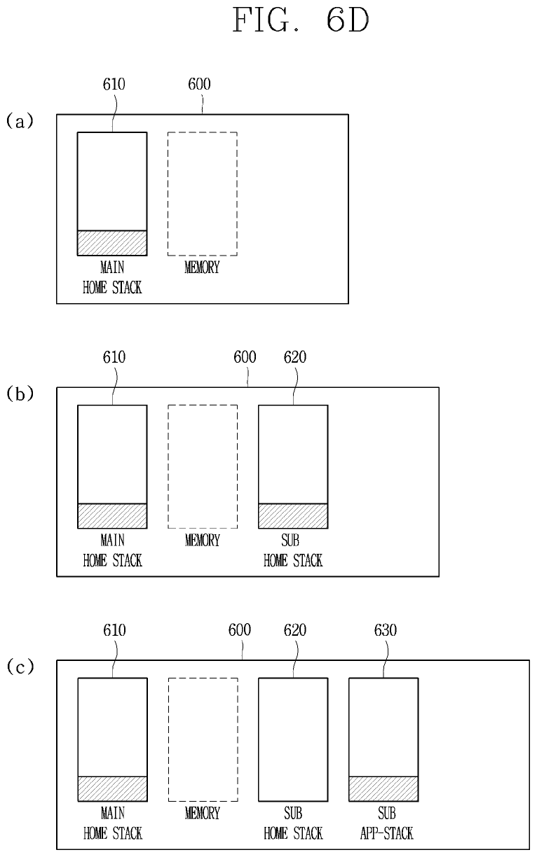

Hereinafter, a flow process of an operation according to the embodiment described above will be described in detail with reference to FIGS. 6A to 6D in connection with the allocation of a memory stack.

Firstly, FIG. 6A illustrates a state in which the connection port of the mobile terminal is connected to the connector of the case, the first display 151 maintains the active state while the electronic device 300 is open, and the second display 250 on the case 200 side is in inactive state in the electronic device 300 according to the embodiment.

When the connection port of the mobile terminal is connected to the connector of the case to sense a plurality of resistances corresponding to the second display 250, action current is supplied to the second display 250 and the circuit board 244 of the case through the first wired communication unit 161, the second wired communication unit 243, and the wiring portion 242.

First screen information may be displayed on the activated first display 151. Here, a type of the first screen information is not limited. For example, the first screen information may be a first home screen page 601 as illustrated in FIG. 6A, and in other examples, the first screen information may be changed in various ways such as an execution screen of a specific application, a web page, a setting screen, etc. according to a setting or a selection of a user.

With respect to the first home screen page 601 being displayed on the first display 151 in active state, a main home stack 610 for the first display 151 may be allocated in a memory 600 of the mobile terminal 100, as illustrated in (a) of FIG. 6D. In addition, tasks related to the displaying of the first home screen page 601 may be stacked on the allocated main home stack 610.

Here, the stacking may be one of structures that stacks (PoP) data. A structure of stacking data may be of a stack type and a queue type. The stack type is a data structure of first-in last-out, and the queue type is a data structure of first-in first-out.

In the present disclosure, stacks for the first display 151 and the second display 250 are separately allocated and removed depending on whether they are activated.

In the open state, the second display 250 in inactive state may be switched to active state when a predetermined time has elapsed after the first display 151 is operated in active state as illustrated in (a) of FIG. 6B, or when a predetermined touch input is applied to the first display 151, for example, to a specific icon as illustrated in (b) of FIG. 6B. Alternatively, although not illustrated, when a touch input is applied to the second display 250, the second display 250 may also be switched to active state.

First, referring to (a) of FIG. 6B, when the electronic device 300 is detected to be switched from the closed state to the open state while action current is supplied to the second display 250 according to sensing of a resistance related to the second display 250, and the first display 151 is operated in active state, a control signal to switch the second display 250 to active state may be transmitted to the second display 250. At this time, the control signal is generated by the mobile terminal 100, and transmitted to the circuit board 244 coupled with the second display 250 via the first wired communication unit 161, the second wired communication unit 243, and the wiring portion 242.

In addition, the image signal corresponding to the screen to be outputted on the second display 250 is also transmitted to the circuit board 244 coupled with the second display 250 via the first wired communication unit 161, the second wired communication unit 243, and the wiring portion 242, together with the control signal or sequentially after the transmission of the control signal. Here, the image signal is transmitted in DP format, converted into MIPI format that can be outputted on the second display 250 by the data converter 282, and provided to the second display 250.

Meanwhile, a condition of the open state for operating the first display 151 in active state and a condition of the open state for operating the second display 250 in active state may be different. For example, the open state in which the second display 250 is operated in active state may be limited to a state in which an angle between the first body 210 and the second body 220 is greater than that in the case of the first display 151.

For example, the first display 151 may be switched to active state when the electronic device 300 is detected to be in open state, and the second display 250 may be switched to active state when the rear surface of the first body 210 and the rear surface of the second body 220 are relatively rotated to be closer to each other after the first display 151 is switched to active state.

Here, in the open state, the angle between the first display 151 and the second display 250 to switch the second display 250 to active state may be preset or changed by a user.

In addition, a setting of whether to switch the second display 250 to active state sequentially after the first display 151 is switched to active state may be on/off based on user input.

Next, referring to (b) of FIG. 6B, when a preset touch input (e.g., touch input applied to a predetermined icon 603 or multi-finger touch gesture) is applied to the first display 151 while action current is supplied to the second display 250, an action corresponding to the touch input, that is, a control signal to switch the second display to the active state may be transmitted to the mobile terminal 100 via USB HID communication.

At this time, since the control signal is a signal related to the touch, the control signal is transmitted to the mobile terminal 100 through the first signal processor 181 and the second signal processor 281 using USB HID communication.

Meanwhile, referring to FIG. 6C, when a preset touch input (e.g., touch input applied to the predetermined icon 603 or multi-finger touch gesture) is again applied to the first display 151 while the second display 250 is operated in active state, the second display 250 is switched to inactive state.

To this end, a control signal corresponding to the touch signal of the preset touch input and to switch the second display 250 into inactive state is transmitted from the mobile terminal to the display 250 using USB communication. Accordingly, the second display 250 is switched back to the inactive state, and the transmission of the image signal from the mobile terminal is stopped.

Meanwhile, as another example, when a preset touch input (e.g., double tap) is applied to the second display while action current is supplied to the second display 250, a touch signal corresponding to the preset touch input is transmitted to the mobile terminal 100 via the circuit board 244 connected to the touch panel, the wiring portion 242 coupled with the first flexible printed circuit board 247 and the second flexible printed circuit board 248, and the first signal processor 181 and the second signal processor 281 using USB HID communication.

Then, the controller 180 of the mobile terminal 100 transmits a control signal to activate the second display 250 to the circuit board coupled with the second screen 251 and the second display 250 via the connector connected with the connection port of the mobile terminal, based on the transmitted touch signal. At this time, since the control signal is a signal related to the touch, the control signal is transmitted to the mobile terminal 100 through the first signal processor 181 and the second signal processor 281 using USB HID communication.

Here, the signal related to the touch is initially transmitted and received through USB 2.0 communication (hereinafter referred to as ‘first USB communication’), then transmitted and received through the switched USB HID communication (hereinafter referred to as ‘second USB communication’) when the mobile terminal 100 is operated in the host mode.

In addition, the control signal is transmitted to the second display 250 through the first wired communication unit 161, the second wired communication unit 243, and the wiring unit 240 in AUX format. The control signal in the AUX format is transmitted to the second display 250 via the second data converter 282.

As described above, when the second display 250 is switched to active state, second screen information, for example, a second home screen page may be displayed on the second display 250.

To this end, the image signal corresponding to the screen to be outputted on the second display 250 is transmitted to the circuit board 244 coupled with the second display 250 via the first wired communication unit 161, the second wired communication unit 243, and the wiring portion 242. Here, the image signal is transmitted in DP format, converted into MIPI format that can be outputted on the second display 250 by the data converter 282, and provided to the second display 250.

Meanwhile, a control signal to switch the second display 250 to active state and the image signal corresponding to the screen to be outputted on the second display 250 are transmitted through different contact pins in the first wired communication unit 161 and the second wired communication unit 243.

With respect to the first home screen page 601 being displayed on the active first display 151, referring to (b) of FIG. 6D, a sub home stack 620 for the second display 250 in addition to the main home stack 610 for the first display 151 is allocated in the memory 600.

At this time, tasks related to the DP type image signal transmitted to the circuit board 244 coupled with the second display 250 via the first wired communication unit 161, the second wired communication unit 243, and the wiring portion 242 is stacked on the sub home stack 620.

The main home stack 610 and the sub home stack 620 are independently controlled, and when a task corresponding to a specific application is executed on the second display 250, a sub-app stack 630 is additionally allocated to the memory and the task corresponding to the specific application is stacked as illustrated in (c) of FIG. 6D.

The controller 180 of the mobile terminal may transmit the DP type image signal corresponding to the task stacked on the sub-app stack 630 to the second display 250 via the circuit board 244 coupled with the second display 250 via the first wired communication unit 161, the second wired communication unit 243, and the wiring portion 242.

Here, the image signal in the DP format is converted into MIPI format by the second data converter 282 so that it can be outputted on the second display 250, and then transmitted to the second display 250. Accordingly, screen information corresponding to the task stacked on the sub-app stack 630 is displayed on the second display 250.

As described above, in the electronic device 300 according to the embodiment, a control signal transmitted to the circuit board connected to the second display 250 and an image signal corresponding to screen information to be displayed on the second display 250 are transmitted through different contact pins.

Meanwhile, as illustrated in FIG. 6C, when the second display 250 is deactivated, the sub-stacks (e.g., sub home stack and sub-application stack) allocated to the memory are deleted from the memory.

Meanwhile, although not illustrated, when the connection port of the mobile terminal and the connector of the case are disconnected so that the wired communication path of the first wired communication unit 161 and the second wired communication unit 243 is released while the second display 250 is activated, supply of operation current is cut off, and the second display 250 is switched to inactive state.

Here, when the connection port of the mobile terminal and the connector of the case are connected again, the second display 250 is switched back to active state, and the screen information displayed on the second display 250 before the connection is cut off may be output again.

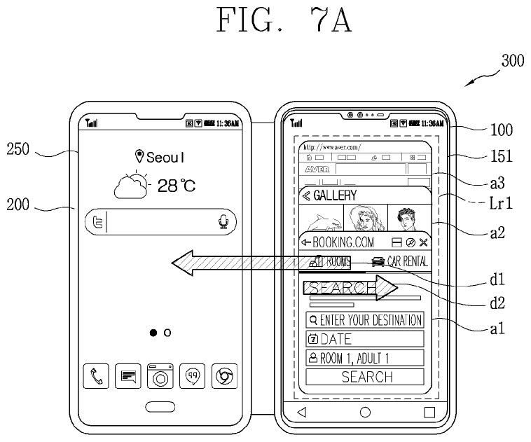

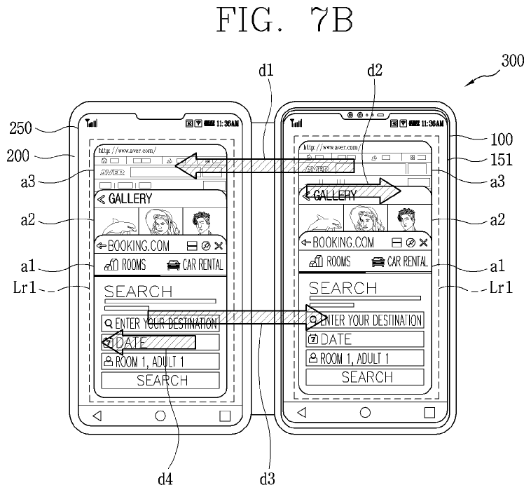

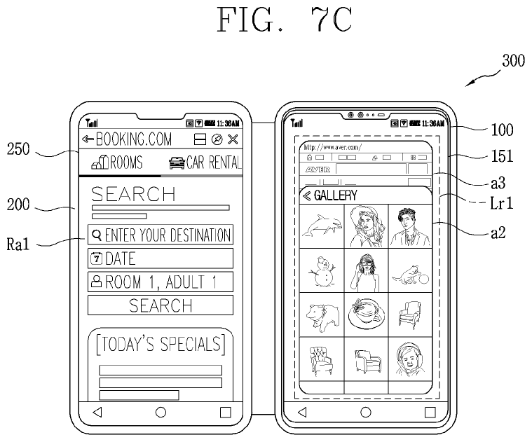

Hereinafter, with reference to FIGS. 7A, 7B, and 7C, a method for controlling application execution screens by the controller according to the embodiment will be described.

FIGS. 7A and 7B are views illustrating a method for controlling application screens according to another embodiment. FIG. 7C is a view illustrating an execution screen of a moved application according to an embodiment.

Referring to FIG. 7A, the controller 180 may display execution list (hereinafter referred to as a list) Lr1 of a plurality of recently executed applications on the first display 151. The plurality of applications may include a first application, a second application, and a third application, but embodiments are not limited thereto.

The list Lr1 may include a thumbnail corresponding to the first application (hereinafter referred to as a first thumbnail a1), a thumbnail corresponding to the second application (hereinafter referred to as a second thumbnail a2), and a thumbnail corresponding to the third application (hereinafter referred to as a third thumbnail a3). That is, the controller 180 may sequentially arrange the first thumbnail a1, the second thumbnail a2, and the third thumbnail a3 in a first direction (e.g., a longitudinal direction) to display them as a list Lr1 on the first display 151.

The first thumbnail a1, the second thumbnail a2, and the third thumbnail a3 may be reduced images of representative screens of each of the recently executed first application, second application, and third application. The representative screen of each of the first thumbnail a1, the second thumbnail a2, and the third thumbnail a3 may be a screen of a recently executed application among the first application, the second application, and the third application, or a screen of an application executed a predetermined number of times or more among the first application, the second application, and the third application, or a screen of an application set by a user, but embodiments are not limited thereto.

In addition, the first thumbnail a1, the second thumbnail a2, and the third thumbnail a3 may be displayed in a direction from a bottom of the first display 151 toward a top of the first display 151. However, the embodiment is not limited thereto.

According to a touch corresponding to any one of the first thumbnail a1, the second thumbnail a2, and the third thumbnail a3, the controller 180 may display a screen of an application corresponding to the touch on the first display 151.

In addition, the controller 180 may detect a first drag d1 corresponding to any one of the first thumbnail a1, the second thumbnail a2, and the third thumbnail a3. The controller 180 may display a screen of an application corresponding to the first drag d1 on the second display 250.

Also, the controller 180 may detect a second drag d2 corresponding to any one of the first thumbnail a1, the second thumbnail a2, and the third thumbnail a3. The controller 180 may end an application corresponding to the second drag d2 according to the second drag d2.

For example, the controller 180 may display a screen of the first application on the first display 151 in response to a touch of the first application a1 among the first thumbnail a1, the second thumbnail a2, and the third thumbnail a3. In addition, the controller 180 may display the screen of the first application on the second display 250 according to the first drag d1 corresponding to the first thumbnail a1 among the first thumbnail a1, the second thumbnail a2, and the third thumbnail a3. In addition, the controller 180 may end the first application according to the second drag d2 corresponding to the first thumb nail a1 among the first thumbnail a1, the second thumbnail a2, and the third thumbnail a3.

A direction of the first drag d1 may be opposite to a direction of the second drag d2. Specifically, the direction of the first drag d1 is a direction from the first display 151 to the second display 250, and the direction of the second drag d2 is a direction from the second display 250 to the first display 151, but the embodiment is not limited thereto.

Referring to FIG. 7B, the controller 180 may display the list Lr1 on the first display 151 and the second display 250, simultaneously, in response to a touch of a user.

According to the first drag d1 corresponding to any one of the first thumbnail a1, the second thumbnail a2, and the third thumbnail a3, the controller 180 may display a screen of an application corresponding to the first drag d1 on the second display 250. According to the second drag d2 corresponding to any one of the first thumbnail a1, the second thumbnail a2, and the third thumbnail a3, the controller 180 may end an application corresponding to the second drag d2.

For example, the controller 180 may display an application screen corresponding to the first thumbnail a1 on the second display 250 in response to the first drag d1 on the first thumbnail a1. In addition, the controller 180 may end the first application according to the second drag d2 corresponding to the first thumbnail a1.

In addition, the controller 180 may detect a third drag d3 and a fourth drag d4 corresponding to any one of the first thumbnail a1, the second thumbnail a2, and the third thumbnail a3. The controller 180 may display a screen of an application corresponding to the third drag d3 on the first display 151. According to the fourth drag d4 corresponding to any one of the first thumbnail a1, the second thumbnail a2, and the third thumbnail a3, the controller 180 may end an application corresponding to the fourth drag d4.

For example, the controller 180 may display an application screen corresponding to the first thumbnail a1 on the first display 151 in response to the third drag d3 on the first thumbnail a1. In addition, the controller 180 may end the application corresponding to the first thumbnail a1 according to the fourth drag d4 on the first thumbnail a1.

A direction of the third drag d3 may be opposite to a direction of the fourth drag d4. Specifically, the direction of the third drag d3 is a direction from the second display 250 to the first display 151, and the direction of the fourth drag d4 is a direction from the first display 151 to the second display 250, but the embodiment is not limited thereto.

Hereinafter, a method in which the controller 180 according to the embodiment displays an execution screen of an application moved by a drag will be described with reference to FIG. 7C.

FIG. 7C is a view illustrating an execution screen of a moved application according to an embodiment.

Referring to FIG. 7C, the controller 180 may display an execution screen Ra1 of an application corresponding to the first thumbnail a1 according to the first drag d1 on the second display 250.

The controller 180 may display the execution screen Ra1 of the application corresponding to the first thumbnail a1 on the second display 250 and delete the first thumbnail a1 from the list Lr1. Accordingly, the second thumbnail a2 and the third thumbnail a3 may be included in the list Lr1.

For convenience of description, an embodiment in which the execution screen Ra1 of the application corresponding to the first thumbnail a1 is displayed on the second display 250 according to the first drag d1 has been described, but also when the list Lr1 is displayed on the second display 250, the execution screen Ra1 of the application corresponding to the first thumbnail a1 may be displayed on the first display 151 according to the third drag d3.

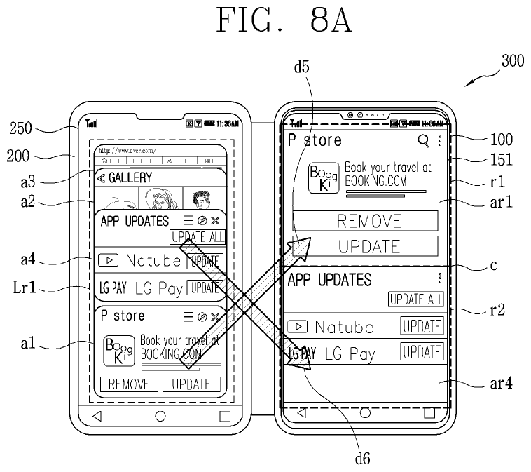

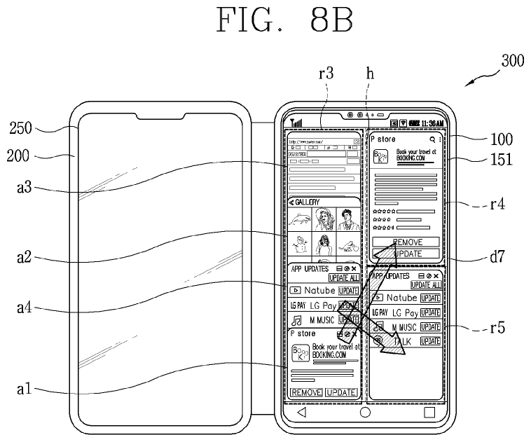

Hereinafter, a method for dividing an execution screen of an application by the controller according to an embodiment will be described with reference to FIGS. 8A and 8B.

FIGS. 8A and 8B are views illustrating a method for dividing an execution screen of an application by a controller according to an embodiment.

Referring to FIG. 8A, the controller 180 may display the list Lr1 on the second display 250. The list Lr1 may include the first thumbnail a1, the second thumbnail a2, the third thumbnail a3, and a thumbnail corresponding to a fourth application (hereinafter referred to as a fourth thumbnail a4). That is, the controller 180 may sequentially arranges the first thumbnail a1, the fourth thumbnail a4, the second thumbnail a2, and the third thumbnail a3 and display them on the second display 250 as a list Lr1.

According to a drag corresponding to any one of the first thumbnail a1, the second thumbnail a2, the third thumbnail a3, and the fourth thumbnail a4, the controller 180 may display a screen of an application corresponding to the drag on a partial region of the first display 151.

For example, the controller 180 may detect a fifth drag d5 corresponding to the first thumbnail a1 and a direction of the fifth drag d5. The controller 180 may display a screen of an application corresponding to a starting point of the fifth drag d5 in a first region r1 of the first display 151 according to the fifth drag d5. The controller 180 may detect a sixth drag d6 corresponding to the fourth thumbnail a4 and a direction of the sixth drag d6. The controller 180 may display a screen of an application corresponding to a starting point of the sixth drag d6 in a second region r2 of the first display 151 according to the sixth drag d6.

The fifth drag d5 and the sixth drag d6 may be drags intersecting each other. The controller 180 may divide the first display 151 into the first region r1 and the second region r2 based on a first center c according to drags in directions crossing each other. The fifth drag d5 and the sixth drag d6 may intersect perpendicularly to each other, but embodiments are not limited thereto, and an area of the first region r1 and an area of the second region r2 may be identical or different.

For convenience of description, although the first display 151 is described as being divided into the first region r1 and the second region r2 based on the first center c, the embodiment is not limited thereto, and the first display 151 may be divided into three or more regions. In addition, the list Lr1 may be displayed on the first display 151, and according to the corresponding drag, the second display 250 may be divided into two or more regions and corresponding application execution screens may be displayed on the divided screen.

Referring to FIG. 8B, the controller 180 may divide the first display 151 into a third region r3, a fourth region r4, and a fifth region r5 based on a second center h. The controller 180 may display the list Lr1 in the third region r3. The list Lr1 may include the first thumbnail a1, the second thumbnail a2, the third thumbnail a3, and the fourth thumbnail a4. That is, the controller 180 may sequentially arranges the first thumbnail a1, the fourth thumbnail a4, the second thumbnail a2, and the third thumbnail a3 and display them on the third region r3 as a list Lr1.

According to a drag corresponding to any one of the first thumbnail a1, the second thumbnail a2, the third thumbnail a3, and the fourth thumbnail a4, the controller 180 may display a screen of an application corresponding to the drag on the fourth region r4 and/or the fifth region r5.

The controller 180 may detect a seventh drag d7 corresponding to the first thumbnail a1 and a direction of the seventh drag d7. The controller 180 may display a screen of an application corresponding to a starting point of the seventh drag d7 in the fourth region r4 according to the seventh drag d6. The controller 180 may detect an eighth drag d8 corresponding to the fourth thumbnail a4 and a direction of the eighth drag d8. The controller 180 may display a screen of an application corresponding to a starting point of the eighth drag d8 in the fifth region r5 according to the eighth drag d8.

The seventh drag d7 and the eighth drag d8 may intersect perpendicularly to each other. An area of the fourth region r4 and an area of the fifth region r5 may be identical or different.

For convenience of description, although the first display 151 is described as being divided into the third region r3, the fourth region r4, and the fifth region r5 based on the second center h, the embodiment is not limited thereto, and the first display 151 may be divided into three or more regions.

In addition, the controller 180 may divide the second display 250 into a third region, a fourth region, and a fifth region based on the second center h. The controller 180 may display the list Lr1 in the third region of the second display 250. According to a drag corresponding to a thumbnail, the controller 180 may display a screen of an application corresponding to the drag on the fourth region of the second display 250 and/or the fifth region of the second display 250.

In addition, although the first display 151 and the second display 250 are described as separate displays, embodiments are not limited thereto, and the first display 151 and the second display 250 may be one display. When the first display 151 and the second display 250 are one display, such one display may be a flexible display.

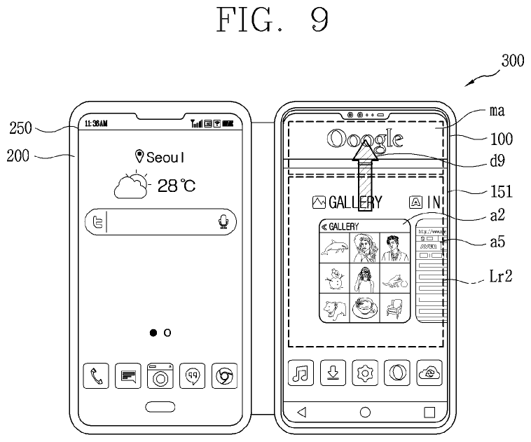

Hereinafter, a method for controlling priorities of lists by a controller according to an embodiment will be described with reference to FIG. 9.

FIG. 9 is a diagram illustrating a method for controlling priorities of lists by a controller according to an embodiment.

Referring to FIG. 9, the controller 180 may display a list Lr2 of a plurality of recently executed applications on the first display 151. The plurality of applications may include the first application and a fifth application but embodiments are not limited thereto.

The list Lr2 may include the second thumbnail a2 and a fifth application thumbnail (hereinafter referred to as a fifth thumbnail a5). That is, the controller 180 may sequentially arrange the second thumbnail a2 and the fifth thumbnail a5 on the first display 151 in a second direction (lateral direction) to display them as a list Lr2. The second direction may be a direction perpendicular to the first direction, but embodiments are not limited thereto.

The controller 180 may detect a drag corresponding to any one of the second thumbnail a2 and the fifth thumbnail a5, and display an application corresponding to the detected drag as a most significant application on a partial region of the first display 151.

For example, when currently most significant application is an application ma, the controller 180 may display a screen of an application corresponding to a starting point of a ninth drag d9 on the first display 151 as a most significant application. That is, the controller 180 may display an application corresponding to the second thumbnail a2 as a most significant application according to the ninth drag d9.

The ninth drag d9 may be a direction from a bottom of the mobile terminal 100 to the top, but the embodiment is not limited thereto.

In the above, for convenience of description the controller 180 is described as displaying the list Lr2 on the first display 151 according to the sixth drag d6, but the embodiment is not limited thereto, and the list Lr2 may be displayed on the first display 151 and/or the second display 250.

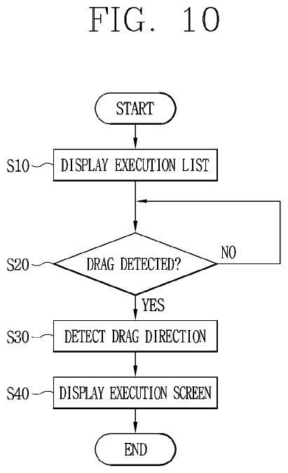

Hereinafter, a method for controlling an electronic device according to an embodiment will be described with reference to FIG. 10.

FIG. 10 is a flowchart illustrating a method for controlling an electronic device according to an embodiment.

Referring to FIG. 10, in step S10, the controller 180 may display the list Lr1 or the list Lr2 of a plurality of recently executed applications on the first display 151 and/or the second display 250.

In step S20, the controller 180 may detect the first drag d1 corresponding to any one of the first thumbnail a1, the second thumbnail a2, and the third thumbnail a3. The controller 180 may detect the second drag d2 corresponding to any one of the first thumbnail a1, the second thumbnail a2, and the third thumbnail a3.

In addition, the controller 180 may detect the third drag d3 and the fourth drag d4 corresponding to any one of the first thumbnail a1, the second thumbnail a2, and the third thumbnail a3. The controller 180 can detect the fifth drag d5 corresponding to the first thumbnail a1. The controller 180 may detect the sixth drag d6 corresponding to the fourth thumbnail a4.

In step S30, the controller 180 detects directions of the first drag d1 to the sixth drag d6.

In step S40, the controller 180 displays execution screens of applications according to the detected directions of the first drag d1 to the sixth drag d6.

For example, the controller 180 may display the screen of the first application on the second display 250 according to the first drag d1 corresponding to the first thumbnail a1. The controller 180 may end the first application according to the second drag d2 corresponding to the first thumbnail a1.

The controller 180 may display a screen of an application corresponding to the third drag d3 on the first display 151. The controller 180 may end an application corresponding to the fourth drag d4 according to the fourth drag d4.

The controller 180 divides the first display 151 into the first region r1 and the second region r2 based on the first center c according to drags in directions crossing each other. The controller 180 may display a screen of an application corresponding to a starting point of the fifth drag d5 in a first region r1 of the first display 151 according to the fifth drag d5. The controller 180 displays a screen of an application corresponding to a starting point of the sixth drag d6 in a second region r2 of the first display 151 according to the sixth drag d6.

The controller 180 may display a screen of an application corresponding to a starting point of the ninth drag d9 as a most significant application on the first display 151. That is, the controller 180 may display an application corresponding to the second thumbnail a2 as a most significant application according to the ninth drag d9.

For convenience of description, the electronic device 300 according to the embodiment has been described as including two displays, but the embodiment is not limited thereto, and the electronic device 300 may include three or more displays.

Also, the list Lr1 and/or the list Lr2 may be simultaneously and/or respectively displayed on the first display 151 and/or the second display 250.

Although the embodiments have been described in detail, the scope of rights of the embodiments is not limited thereto, and various modifications and improvements of those skilled in the art using the basic idea of the embodiments defined in the claims below also belong to the scope of rights of the embodiments.

Therefore, it should also be understood that the above-described embodiments are not limited by any of the details of the foregoing description, unless otherwise specified, but rather should be construed broadly within its scope as defined in the appended claims. All changes and modifications that fall within the metes and bounds of the claims, or equivalents of such metes and bounds are therefore intended to be embraced by the appended claims.

What is claimed is:

1. An electronic device comprising:
a mobile terminal on which a plurality of applications are executed; and
a case,
wherein the mobile terminal comprises:
a terminal body coupled to the case;
a connection port provided on one side of the terminal body;
a first display; and
a controller,
wherein the case comprises:
a first body accommodating the mobile terminal;
a second body rotatably coupled to the first body;
a connector protruded toward an inner side of the first body and inserted into the connection port;
a second display provided on the second body; and
a connection portion disposed between the first display and the second display and electrically coupling the second display with the first body and the second body, and
wherein the controller is configured to:
cause the first display to display a list of the plurality of applications; and
cause the second display to display an execution screen of an application among the plurality of applications in response to a drag input received on the list.

2. The electronic device of claim 1, wherein:
the list includes a plurality of thumbnails corresponding to the plurality of applications;
each of the plurality of thumbnails is a representative screen of a corresponding one of the plurality of applications; and
the plurality of thumbnails are displayed sequentially on the first display in a vertical or horizontal direction.

3. The electronic device of claim 2, wherein:
the plurality of thumbnails include a first thumbnail corresponding to a first application;
the drag input includes a first drag and a second drag corresponding to the first thumbnail;
the controller is further configured to:
cause the second display to display a first execution screen of the first application according to the first drag; and
end the first application according to the second drag; and
a direction of the first drag is opposite to a direction of the second drag.

4. The electronic device of claim 3, wherein the direction of the first drag is from the first display to the second display, and the direction of the second drag is from the second display to the first display.

5. The electronic device of claim 1, wherein:
the controller is further configured to:
cause both the first display and the second display to display the list simultaneously, the list including a plurality of thumbnails corresponding to the plurality of applications, and the plurality of thumbnails including a second thumbnail corresponding to a second application among the plurality of applications;
cause the first display to display a second execution screen of the second application in response to a third drag corresponding to the second thumbnail and received on the second display; and
end the second application in response to a fourth drag received on the second display, the fourth drag corresponding to the second thumbnail; and
a direction of the third drag is opposite to a direction of the fourth drag.

6. The electronic device of claim 5, wherein the direction of the third drag is from the second display to the first display, and the direction of the fourth drag corresponds to a direction from the first display toward the second display.

7. The electronic device of claim 1, wherein:
the controller is further configured to:
cause the second display to display a list including a plurality of thumbnails corresponding to the plurality of applications, the plurality of thumbnails including a first thumbnail corresponding to a first application and a second thumbnail corresponding to a second application; and
divide the first display into a first region and a second region in response to a fifth drag corresponding to the first thumbnail and a sixth drag corresponding to the second thumbnail; and
the fifth drag and the sixth drag initiated from the list displayed on the second display cross each other.

8. The electronic device of claim 7, wherein the controller is further configured to cause the first display to:
display a first execution screen of the first application in the first region according to the fifth drag, and
display a second execution screen of the second application in the second region according to the sixth drag, and
wherein the fifth drag and the sixth drag intersect each other perpendicularly.

9. The electronic device of claim 1, wherein:
the list includes a plurality of thumbnails corresponding to the plurality of applications;
each of the plurality of thumbnails is a representative screen of a corresponding one of the plurality of applications;
the plurality of thumbnails are displayed sequentially on the first display;
the controller is further configured to cause the first display to display an application corresponding to a seventh drag among the plurality of applications in a designated area of the first display in response to the seventh drag; and
the seventh drag is received within the first display and corresponds to any one of the plurality of thumbnails included in the list.

10. A method for controlling an electronic device comprising a mobile terminal and a case,
wherein the mobile terminal comprises:
a terminal body coupled to the case;
a connection port provided in the terminal;
a first display; and
a controller,
wherein the case comprises:
a first body accommodating the mobile terminal;
a second body rotatably coupled to the first body;
a connector protruded toward an inner side of the first body and inserted into the connection port;
a second display provided on the second body; and
a connection portion disposed between the first display and the second display and electrically coupling the second display with the first body and the second body, and
wherein the method comprises:
displaying a list of the plurality of applications on the first display; and
displaying an execution screen of an application among the plurality of applications on the second display in response to a drag input received on the list.

11. The method of 10, wherein:
the list includes a plurality of thumbnails corresponding to the plurality of applications;
each of the plurality of thumbnails is a representative screen of a corresponding one of the plurality of executed applications; and
the plurality of thumbnails are displayed sequentially in a vertical or horizontal direction on the first display.

12. The method of 11, wherein:
the plurality of thumbnails include a first thumbnail corresponding to a first application;
the drag input includes a first drag and a second drag corresponding to the first thumbnail,
the method further comprises:
displaying a first execution screen of the first application according to the first drag; and
ending the first application according to the second drag; and
a direction of the first drag is opposite to a direction of the second drag.

13. The method of 12, wherein the direction of the first drag is from the first display to the second display, and the direction of the second drag is from the second display to the first display.

14. The method of 10, further comprising:
displaying the list on both the first display and the second display simultaneously, the list including a plurality of thumbnails corresponding to the plurality of applications, and the plurality of thumbnails including a second thumbnail corresponding to a second application among the plurality of applications;
displaying a second execution screen of the second application on the first display in response to a third drag corresponding to the second thumbnail and received on the second display; and
ending the second application in response to a fourth drag received on the second display,
wherein a direction of the third drag is opposite to a direction of the fourth drag.

15. The method of 14, wherein the direction of the third drag is from the second display to the first display, and the direction of the fourth drag corresponds to a direction from the first display toward the second display.

16. The method of claim 10, further comprising:
displaying a list including a plurality of thumbnails corresponding to the plurality of applications on the second display, the plurality of thumbnails including a first thumbnail corresponding to a first application and a second thumbnail corresponding to a second application; and
dividing the first display into a first region and a second region in response to a fifth drag corresponding to the first thumbnail and a sixth drag corresponding to the second thumbnail,
wherein the fifth drag and the sixth drag initiated from the list displayed on the second display cross each other.

17. The method of claim 16, further comprising:
displaying a first execution screen of the first application in the first region according to the fifth drag; and
displaying a second execution screen of the second application in the second region according to the sixth drag,
wherein the fifth drag and the sixth drag intersect each other perpendicularly.

18. The method of claim 10, wherein:
the list includes a plurality of thumbnails corresponding to the plurality of applications;
each of the plurality of thumbnails is a representative screen of a corresponding one of the plurality of applications;
the plurality of thumbnails are displayed sequentially on the first display; and
the method further comprises displaying an application corresponding to a seventh drag among the plurality of applications in a designated area of the first display in response to the seventh drag; and
the seventh drag is received within the first display and corresponds to any one of the plurality of thumbnails included in the list.

19. An electronic device comprising a mobile terminal on which a plurality of applications are executed,
wherein the mobile terminal comprises a display and a controller,
wherein the plurality of applications include a first application and a second application, and
wherein the controller is configured to:
divide the display into a first region, a second region, and a third region;
cause a first thumbnail corresponding to the first application and a second thumbnail corresponding to the second application to be displayed in the first region;
detect a first drag corresponding to the first thumbnail and a second drag corresponding to the second thumbnail; and
cause a first execution screen of the first application to be displayed on the second region according to the first drag; and
cause a second execution screen of the second application to be displayed on the third region according to the second drag.
